(19) United States
(12) Patent Application Publication
(10) Pub. No.: US 2026/0177967 A1
(43) Pub. Date: Jun. 25, 2026

(54) MEDIUM PROCESSING APPARATUS AND IMAGE FORMING SYSTEM

(71) Applicants: Sho ASANO, Kanagawa (JP); Yuusuke SHIBASAKI, Tokyo (JP); Wataru Takahashi, Tokyo (JP); Tomomichi HOSHINO, Kanagawa (JP); Atsushi SHINODA, Kanagawa (JP); Shota YOSHIDA, Kanagawa (JP); Kotomi KAMEYAMA, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(72) Inventors: Sho ASANO, Kanagawa (JP); Yuusuke SHIBASAKI, Tokyo (JP); Wataru Takahashi, Tokyo (JP); Tomomichi HOSHINO, Kanagawa (JP); Atsushi SHINODA, Kanagawa (JP); Shota YOSHIDA, Kanagawa (JP); Kotomi KAMEYAMA, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(73) Assignee: ETRIA Co., Ltd., Kanagawa (JP)

(21) Appl. No.: 19/357,759

(22) Filed: Oct. 14, 2025

(30) Foreign Application Priority Data
Dec. 19, 2024 (JP) 2024-224238

(51) Int. Cl. G03G 15/00

(52) U.S. Cl. CPC G03G 15/6544; G03G 15/5004; G03G 2215/00565; G03G 2215/00611

(57) ABSTRACT

A medium processing apparatus includes a stacker, a first direction aligner, a second direction aligner, a binder, a drive source, and a switch. The stacker stacks media conveyed in a conveyance direction. The first direction aligner aligns a position of the media in the conveyance direction. The second direction aligner aligns a position of the media in a main scanning direction. The binder binds a media bundle of the media on the stacker. The drive source moves the second direction aligner in a first-side direction and a second-side direction. The switch switches the first direction aligner between a first state where the first direction aligner is allowed to move in the first-side direction by the second direction aligner and is restricted to move in the second-side direction and a second state where the first direction aligner is allowed to move in the second-side direction.

### CROSS-REFERENCE TO RELATED APPLICATION

This patent application is based on and claims priority pursuant to 35 U.S.C. § 119 (a) to Japanese Patent Application No. 2024-224238, filed on Dec. 19, 2024, in the Japan Patent Office, the entire disclosure of which is hereby incorporated by reference herein.

### BACKGROUND

### Technical Field

The present disclosure relates to a medium processing apparatus and an image forming system.

### Related Art

Typically, there has been known a medium processing apparatus in which a plurality of media (referred to as “medium bundle” below) accumulated in a stacker is aligned in a conveyance direction by a conveyance direction alignment unit, aligned in a main scanning direction by a main scanning direction alignment unit, and then bound by a binding device. Among such medium processing apparatuses, there is a medium processing apparatus which can switch the positions of the conveyance direction alignment unit and the main scanning direction alignment unit in accordance with the size of the medium. Further, the main scanning direction alignment unit aligns the positions in the main scanning direction by moving in a manner of sandwiching the medium bundle accumulated in the stacker from both sides in the main scanning direction (so-called jogging).

However, in the medium processing apparatus in the art, the conveyance direction alignment unit and the main scanning direction alignment unit move in conjunction with each other at a position other than the innermost position in the main scanning direction. Therefore, there is a problem that at the time of jogging, the medium bundle accumulated in the stacker and the conveyance direction alignment unit are rubbed against each other, deteriorating the quality of the medium bundle.

### SUMMARY

Embodiments of the present disclosure described herein provide a novel medium processing apparatus including a stacker, a first direction aligner, a second direction aligner, a binder, a drive source, and a switch. The stacker stacks media conveyed in a conveyance direction. The first direction aligner aligns a position of the media on the stacker, in the conveyance direction. The second direction aligner aligns a position of the media on the stacker, in a main scanning direction orthogonal to the conveyance direction. The second direction aligner is contactable with the first direction aligner to move the first direction aligner. The binder binds a media bundle of the media on the stacker. The drive source moves the second direction aligner in one of the main scanning direction as a first-side direction to move the first direction aligner and another of the main scanning direction as a second-side direction opposite to the first-side direction. The switch to switch the first direction aligner between a first state and a second state. In the first state, the first direction aligner is allowed to move in the first-side direction by the second direction aligner, and the first direction aligner is restricted to move in the second-side direction. In the second state, the first direction aligner is allowed to move in the second-side direction.

Further, embodiments of the present disclosure described herein provide an image forming system including an image forming apparatus to form an image on a medium, and the above-described medium processing apparatus to bind the media bundle of media including the medium on which the image is formed by the image forming apparatus.

Further, embodiments of the present disclosure described herein provide an image forming system including an image forming device, a stacker, a first direction aligner, a second direction aligner, a binder, a drive source, and a switch. The image forming device forms an image on a medium. The stacker stacks media conveyed from and passed through the image forming device in a conveyance direction. The first direction aligner aligns a position of the media on the stacker, in the conveyance direction. The second direction aligner aligns a position of the media on the stacker, in a main scanning direction orthogonal to the conveyance direction. The second direction aligner is contactable with the first direction aligner to move the first direction aligner. The binder binds a media bundle of the media on the stacker. The drive source moves the second direction aligner in one of the main scanning direction as a first-side direction to move the first direction aligner and another of the main scanning direction as a second-side direction opposite to the first-side direction. The switch switches the first direction aligner between a first state and a second state. In the first state, the first direction aligner is allowed to move in the first-side direction by the second direction aligner, and the first direction aligner is restricted to move in the second-side direction. In the second state, the first direction aligner is allowed to move in the second-side direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an internal configuration of an image forming apparatus;

FIG. 2A is a side view illustrating an internal configuration of a sheet binder according to a first embodiment;

FIG. 2B is a plan view illustrating a position of a conveyance path;

FIG. 3 is a plan view illustrating a position of an internal tray of the sheet binder according to the first embodiment;

FIGS. 4A and 4B are diagrams each illustrating a state of the sheet binder until a sheet reaches a conveyance roller pair;

FIGS. 5A and 5B are diagrams each illustrating a state of the sheet binder performing a binding process;

FIG. 6 is a diagram illustrating the sheet binder in the state illustrated in FIG. 5B as viewed from a sheet thickness direction;

FIGS. 7A and 7B are diagrams illustrating the sheet binder in a state where a sheet bundle subjected to the binding process is discharged to a discharge tray;

FIG. 8 is a plan view of a moving mechanism of an end fence and a side fence;

FIG. 9 is a perspective view of the moving mechanism of the end fence and the side fence;

FIG. 10 is a perspective view in which an internal tray is omitted from FIG. 9;

FIG. 11 is an enlarged view of a switching mechanism;

FIGS. 12A, 12B, 12C and 12D are diagrams illustrating a process in which the switching mechanism is switched from a first state to a second state;

FIGS. 13A, 13B, 13C and 13D are diagrams illustrating a process in which the switching mechanism is switched from the second state to the first state;

FIGS. 14A and 14B are diagrams each illustrating an example of arrangement of position sensors;

FIGS. 15A, 15B and 15C are diagrams each illustrating a variation of a positional relationship between a coil spring and the switching mechanism;

FIG. 16 is a diagram illustrating another example of FIG. 8;

FIG. 17 is an example of a hardware configuration diagram of the image forming apparatus;

FIG. 18 is another example of the hardware configuration diagram of the image forming apparatus;

FIG. 19 is a flowchart of a binding control process according to the first embodiment;

FIG. 20 is a diagram illustrating a state in which the end fence is moved to a standby position;

FIG. 21 is a diagram illustrating a state in which the side fence is moved to a standby position;

FIGS. 22A and 22B are flowcharts of moving the end fence and the side fence to home positions;

FIG. 23 is a diagram illustrating a state in which an end fence and a side fence according to a second embodiment are arranged at home positions;

FIG. 24 is a diagram illustrating a state in which the end fence according to the second embodiment is arranged at a standby position; and

FIG. 25 is a diagram illustrating a state in which the side fence according to the second embodiment is arranged at a standby position.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

A description is now given of an image forming apparatus 1 according to the present disclosure, with reference to the drawings.

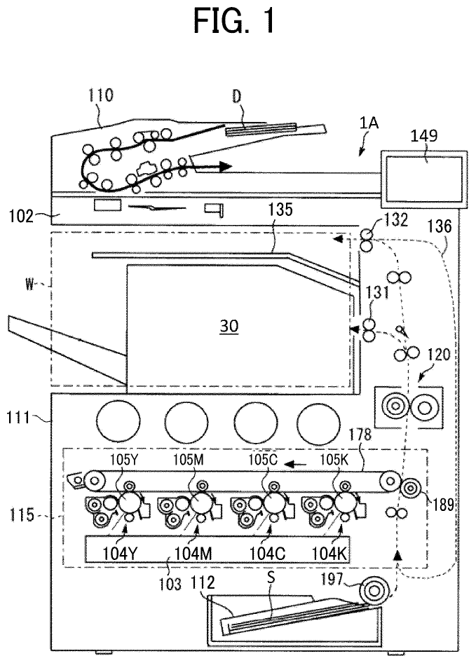

FIG. 1 is a diagram illustrating an internal configuration of the image forming apparatus 1.

The image forming apparatus 1 is an apparatus that forms an image on a sheet S which is an example of a sheet-like medium (representatively, a sheet of paper). As illustrated in FIG. 1, the image forming apparatus 1 mainly includes a housing 111 and an image forming device 115 (image forming device).

The housing 111 has a box shape to form an internal space for accommodating components of the image forming apparatus 1. The housing 111 has an in-body space W that is accessible from the outside of the image forming apparatus 1. The in-body space Wis located, for example, slightly above the center of the housing 111 in the vertical direction. An outer wall of the housing 111 has been cut out to expose the in-body space W to the outside. In the in-body space W, a processing apparatus (for example, an optional apparatus, a sheet binder 30) that performs various types of processing on the sheet S on which an image is formed by the image forming device 115 is arranged. The in-body space W is a space to which the sheet S discharged from the image forming apparatus 1 can be discharged, and is also a space from which the discharged sheet S can be taken out.

In the in-body space W of the image forming apparatus 1, for example, as illustrated in FIG. 1, the sheet binder 30 (medium processing apparatus) is arranged. In this configuration, a plurality of sheets S on which an image is formed by the image forming device 115 is subjected to a binding process by the sheet binder 30 and discharged to a discharge tray 32.

As another example, the optional apparatus and the sheet binder 30 may be arranged in the in-body space W of the image forming apparatus 1. In this configuration, the plurality of sheets S on which an image is formed by the image forming device 115 is subjected to a process (for example, a liquid applying process for a binding position, a punching process for a punch hole, or a folding process) by the optional apparatus, then subjected to the binding process by the sheet binder 30, and discharged to the discharge tray 32.

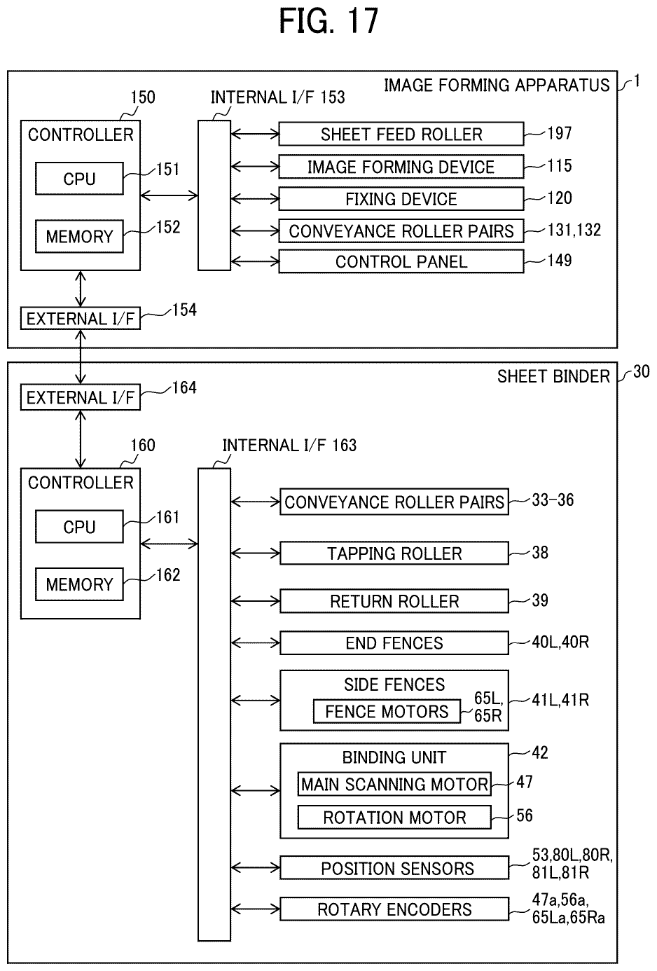

Each of the optional apparatus and the sheet binder 30 is made a unit and has an input and output interface that can be connected to each other to convey the sheet S. In other words, an optional apparatus 20 and the sheet binder 30 are replaceable according to the application of the image forming apparatus 1. More particularly, the input interfaces of the optional apparatus and the sheet binder 30 can be connected to the output interface of the image forming device 115. In addition, the input interface of the sheet binder 30 can also be connected to the output interface of the optional apparatus. Adjacent units are detachably connected to each other via, for example, a mechanical lock, or a magnet. The apparatuses arranged in the in-body space W are each connected to a controller 150 (see FIG. 17) via a harness for transmitting and receiving various signals.

As still another example, the image forming apparatus 1 may constitute an image forming system in combination with a post-processing apparatus mounted outside the in-body space W. The post-processing apparatus may be, for example, an apparatus that performs a sorting process of sorting a sheet bundle Sb (medium bundle) discharged from the sheet binder 30. Further, in the in-body space W of the image forming apparatus 1, a relay device that relays the sheet S on which an image is formed and which has been discharged into the in-body space W to the post-processing apparatus may be arranged. The relay device may be integrated with the post-processing apparatus, or may be separately configured and mounted. The post-processing apparatus may be the sheet binder 30.

The image forming apparatus 1 mainly includes a document conveying device 110, a document reading device 102, a sheet tray 112, a sheet feed roller 197, the image forming device 115, a fixing device 120, conveyance roller pairs 131 and 132 (conveying unit), and a discharge tray 135. In the present description, an example of the image forming device 115 of an electrophotographic type that forms images using toner will be described, but an inkjet type that forms images using ink may also be used.

The document conveying device 110 conveys a document D on which an image has already been formed toward the document reading device 102. The document reading device 102 optically reads the image formed on the document D conveyed by the document conveying device 110 and generates image data. As a reading element of the document reading device 102, for example, a charge coupled device (CCD) sensor, or a complementary metal oxide semiconductor (CMOS) sensor can be used.

The sheet tray 112 laminates and accommodates the plurality of sheets S. The sheet feed roller 197 feeds the sheets S accommodated in the sheet tray 112 one by one toward the image forming device 115. The image forming device 115 forms an image indicated by the image data generated by the document reading device 102 (alternatively, received from an external device via a communication network) on the sheet S fed by the sheet feed roller 197. The image forming device 115 includes a writing device 103, image forming units 104Y, 104M, 104C, and 104K, an intermediate transfer belt 178, and a secondary transfer roller 189.

The writing device 103 converts the image indicated by the image data into laser beams of a plurality of colors (yellow, magenta, cyan, and black), and irradiates photoconductor drums 105Y, 105M, 105C, and 105K of the image forming units 104Y, 104M, 104C, and 104K with the laser beams. As a result, images of corresponding colors are formed on the surfaces of the photoconductor drums 105Y, 105M, 105C, and 105K. Images of respective colors formed on the photoconductor drums 105Y, 105M, 105C, and 105K are superimposed and transferred onto the intermediate transfer belt 178, forming a color image. The secondary transfer roller 189 transfers the color image formed on the intermediate transfer belt 178 to the sheet S fed by the sheet feed roller 197, and conveys the sheet S to the fixing device 120.

The fixing device 120 fixes the image transferred to the sheet S by the secondary transfer roller 189 and conveys the image to the conveyance roller pairs 131 and 132. The conveyance roller pair 131 conveys the sheet S which has passed through the fixing device 120 toward the sheet binder 30 arranged in the in-body space W. The conveyance roller pair 132 conveys the sheet S which has passed through the fixing device 120 toward the discharge tray 135 arranged in the in-body space W. Alternatively, the conveyance roller pair 132 inverts the front and back of the sheet S which has passed through the fixing device 120 through an inverting conveyance path 136 and supplies the sheet S to the image forming device 115 again. The destination of the sheet S which has passed through the fixing device 120 is switched by, for example, a user operation (or an instruction from an external device) through a control panel 149.

### FIRST EMBODIMENT

### Configuration of Sheet Binder

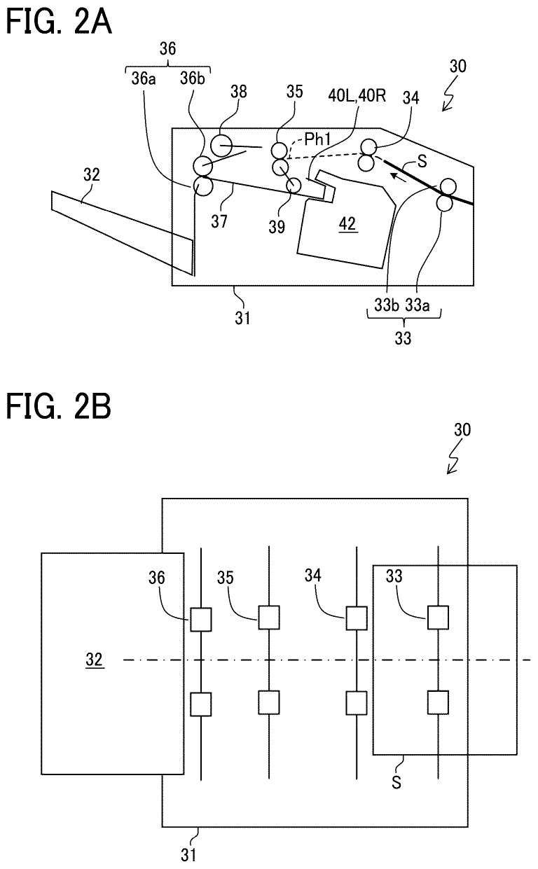

FIG. 2A is a side view illustrating an internal configuration of the sheet binder 30 according to a first embodiment.

FIG. 2B is a plan view illustrating a position of a conveyance path Ph1.

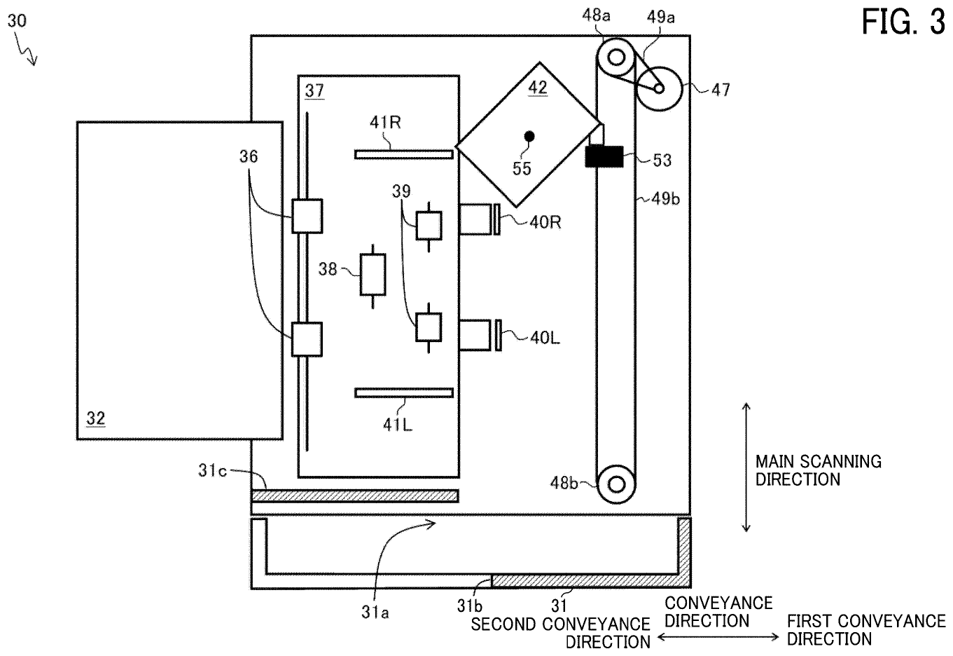

FIG. 3 is a plan view illustrating a position of an internal tray 37 of the sheet binder 30 according to the first embodiment.

The sheet binder 30 as a medium processing apparatus performs the binding process (post-process) of binding the plurality of sheets S (sheet bundle Sb) on which images have been formed by the image forming device 115. As illustrated in FIGS. 2A, 2B and 3, the sheet binder 30 includes a binding case 31, the discharge tray 32, multiple conveyance roller pairs 33, 34, 35, and 36 (conveyance unit), the internal tray 37 (stacker), a tapping roller 38, a return roller 39, end fences 40L and 40R (conveyance direction alignment unit, in other words, first aligner), side fences 41L and 41R (main scanning direction alignment unit, in other words, second aligner), and a binding unit 42.

In the present description, among the conveyance directions of the sheet S or the sheet bundle Sb supported by the internal tray 37, a direction approaching the end fences 40L and 40R is referred to as “first conveyance direction”, and a direction away from the end fences 40L and 40R is referred to as “second conveyance direction”. In other words, the first conveyance direction and the second conveyance direction are opposite to each other. The first conveyance direction and the second conveyance direction may be collectively referred to simply as “conveyance direction”.

In addition, in the present description, among the conveyance directions and the main scanning direction orthogonal to the thickness direction of the sheet S supported by the internal tray 37, a direction toward the center of the sheet S or the sheet bundle Sb supported by the internal tray 37 (one side in the main scanning direction) is referred to as “first main scanning direction”, and a direction toward an end opposite to the center in the main scanning direction of the sheet S or the sheet bundle Sb supported by the internal tray 37 (the other side in the main scanning direction) is referred to as “second main scanning direction”. The first main scanning direction and the second main scanning direction may be collectively referred to simply as “main scanning direction”.

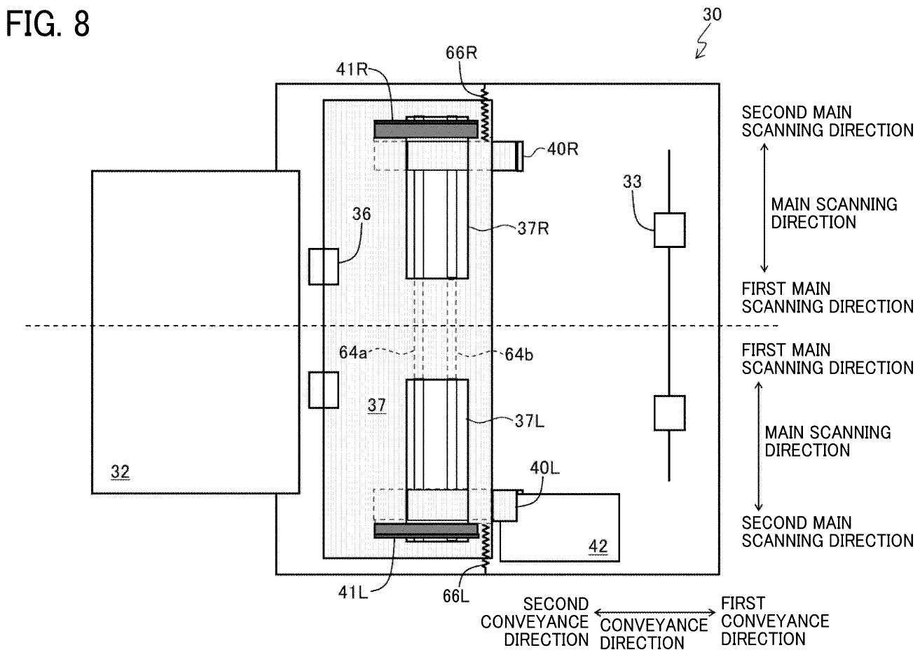

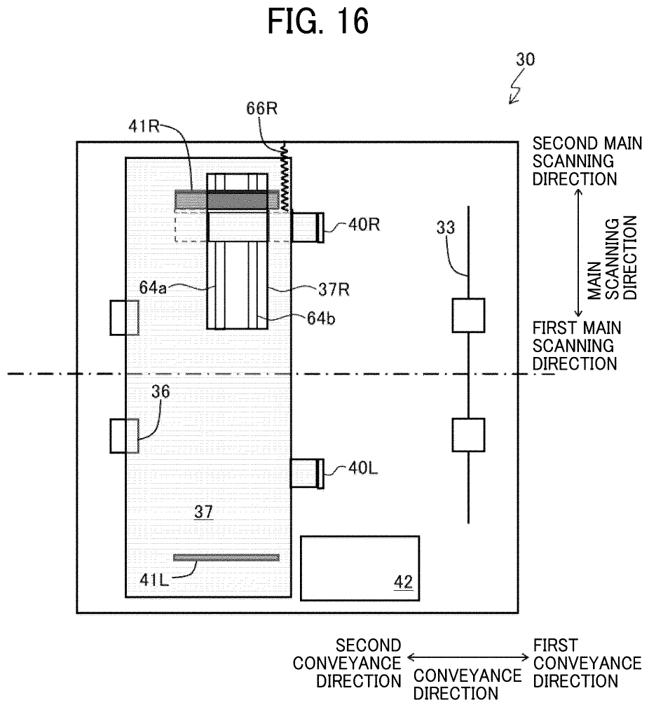

In other words, for example, as illustrated in FIG. 8, the first main scanning direction and the second main scanning direction are opposite to each other across the center in the main scanning direction of the sheet S or the sheet bundle Sb supported by the internal tray 37. In the present embodiment, it is assumed that the internal tray 37 is a so-called “center alignment” internal tray in which the center of the sheet S is generally arranged at the same position regardless of the size of the sheet S. As another example, as illustrated in FIG. 16, the present disclosure can also be applied to the so-called “side alignment” internal tray 37 in which one of the side fences 41L and 41R is fixed, and the other of the side fences 41L and 41R moves, whereby the ends in the main scanning direction of the sheets S of different sizes are generally arranged at the same position.

The binding case 31 has a box shape to form an internal space for accommodating components of the sheet binder 30. The conveyance path Ph1 is formed in the internal space of the binding case 31. The conveyance path Ph1 is a space through which the sheet S passes. The discharge tray 32 is supported on an outer side surface of the binding case 31. The discharge tray 32 stacks the sheet S or the sheet bundle Sb conveyed by the conveyance roller pairs 33 to 36.

The conveyance roller pairs 33 to 36 are arranged on the conveyance path Ph1 at predetermined intervals. The conveyance roller pairs 33 to 36 convey the sheet S along the conveyance path Ph1. The conveyance roller pair 33 is configured of a driving roller 33a and a driven roller 33b that are arranged to face each other across the conveyance path Ph1. The driving roller 33a and the driven roller 33b are rotatably supported by the binding case 31. A rotary driving force of a conveyance motor is transmitted to the driving roller 33a to rotate the driving roller 33a forward in a direction of conveying the sheet S (clockwise direction in FIGS. 2A and 2B). The driven roller 33b is arranged to face the driving roller 33a across the conveyance path Ph1 and is driven by the rotation of the driving roller 33a. As the conveyance motor is driven with the driving roller 33a and the driven roller 33b nipping the sheet S, the sheet S is conveyed along the conveyance path Ph1.

The conveyance roller pairs 34 to 36 each have a basic configuration in common with the conveyance roller pair 33. Here, the conveyance roller pair 36 includes a driving roller 36a and a driven roller 36b that can be brought into contact with and separated from the driving roller 36a. The conveyance roller pair 35 may be slidable in a width direction in order to implement a sorting process in which the sheet S is shifted in the width direction and discharged to the discharge tray 32.

The internal tray 37 temporarily supports (accumulates) the plurality of sheets S conveyed by the conveyance roller pair 36. The tapping roller 38 is supported at a distal end of a rotation arm above the internal tray 37. As the rotation arm is rotated, the tapping roller 38 supplies the sheet S to the internal tray 37. The return roller 39 contacts the upper surface of the sheet S supported by the internal tray 37 and rotates to guide the sheet S toward the conveyance roller pair 36.

The end fences 40L and 40R contact the downstream end in the first conveyance direction of the sheet S supported by the internal tray 37 to align the position in the conveyance direction of the sheet S. The side fences 41L and 41R contact both ends in the main scanning direction of the sheet S supported by the internal tray 37 to align the position in the main scanning direction of the sheet S.

A detailed description is given below of the operation of the end fences 40L and 40R and the side fences 41L and 41R, with reference to FIGS. 8 to 13D.

The binding unit 42 (binding device) is arranged at a downstream end in the first conveyance direction of the sheet bundle Sb supported by the internal tray 37. The binding unit 42 is movable in the main scanning direction along the sheet bundle Sb supported by the internal tray 37. Further, the binding unit 42 is rotatable around a rotation shaft 55 extending in the thickness direction of the sheet S supported by the internal tray 37. As an example, the binding unit 42 may be a press-bonding binding device that presses and deforms the sheet bundle Sb to bind the sheet bundle Sb. As another example, the binding unit 42 is a needle binding device that causes a binding needle to penetrate the sheet bundle Sb to bind the sheet bundle Sb. As still another example, the sheet binder 30 may include both the press-bonding binding device and the needle binding device.

The binding unit 42 is movable in the main scanning direction by a main scanning motor 47, a driving pulley 48a, a driven pulley 48b, and endless annular belts 49a and 49b. The main scanning motor 47 generates a driving force for moving the binding unit 42 in the main scanning direction. The driving pulley 48a and the driven pulley 48b are rotatably supported by the binding case 31 respectively at positions separated from each other in the main scanning direction. The endless annular belt 49a is stretched around an output shaft of the main scanning motor 47 and the driving pulley 48a. The endless annular belt 49b is stretched around the driving pulley 48a and the driven pulley 48b. The binding unit 42 is attached to the endless annular belt 49b.

The driving force of the main scanning motor 47 is transmitted to the driving pulley 48a through the endless annular belt 49a. The endless annular belt 49b circulates around the driving pulley 48a and the driven pulley 48b as the driving pulley 48a rotates. As a result, the binding unit 42 attached to the endless annular belt 49b moves in the main scanning direction. The driving pulley 48a, the driven pulley 48b, and the endless annular belts 49a and 49b are an example of a driving force transmission mechanism that transmits the driving force of the main scanning motor 47 to the binding unit 42. Here, the specific configuration of the driving force transmission mechanism is not limited to the above-described example.

The sheet binder 30 includes a position sensor 53. The position sensor 53 detects the position of the binding unit 42 in the main scanning direction. For example, the position sensor 53 outputs a position signal to a controller 160 when the binding unit 42 is arranged at a predetermined position (home position) in the main scanning direction, and stops outputting the position signal when the binding unit 42 is arranged at a position different from the home position. The specific configuration of the position sensor 53 is not particularly limited, and for example, a mechanical sensor, an optical sensor, or a magnetic sensor can be adopted.

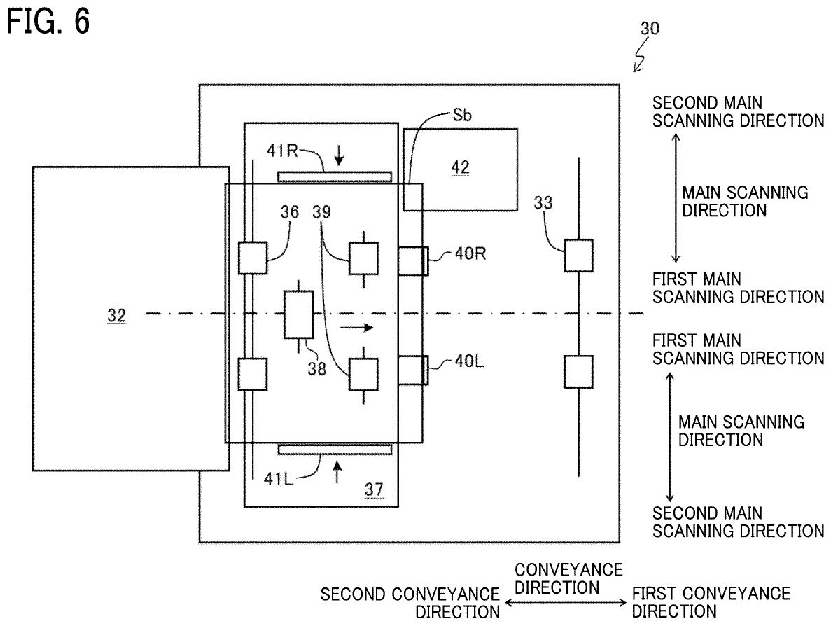

The binding unit 42 is rotatably supported by the binding case 31 around the rotation shaft 55 extending in the thickness direction of the sheet S supported by the internal tray 37. The binding unit 42 rotates between a parallel binding posture illustrated in FIG. 6 and an oblique binding posture illustrated in FIG. 3 by the transmission of the driving force of a rotation motor 56 (see FIG. 17).

A slit 31a for manual binding is provided at a position facing the binding unit 42 of the binding case 31. A corner of the sheet bundle Sb inserted into the binding case 31 through the slit 31a can be manually bound by the binding unit 42. The binding case 31 further includes guide walls 31b and 31c in a manner of surrounding the slit 31a. The guide wall 31b positions the sheet bundle Sb to be manually bound (in other words, the sheet bundle Sb having a corner to be inserted into the slit 31a) in the conveyance direction. The guide wall 31c positions the sheet bundle Sb to be manually bound (in other words, the sheet bundle Sb having a corner to be inserted into the slit 31a) in the main scanning direction. In the main scanning direction below, a side close to the slit 31a is referred to as “front side”, and a side far from the slit 31a is referred to as “back side”.

### Basic Operation of Sheet Binder

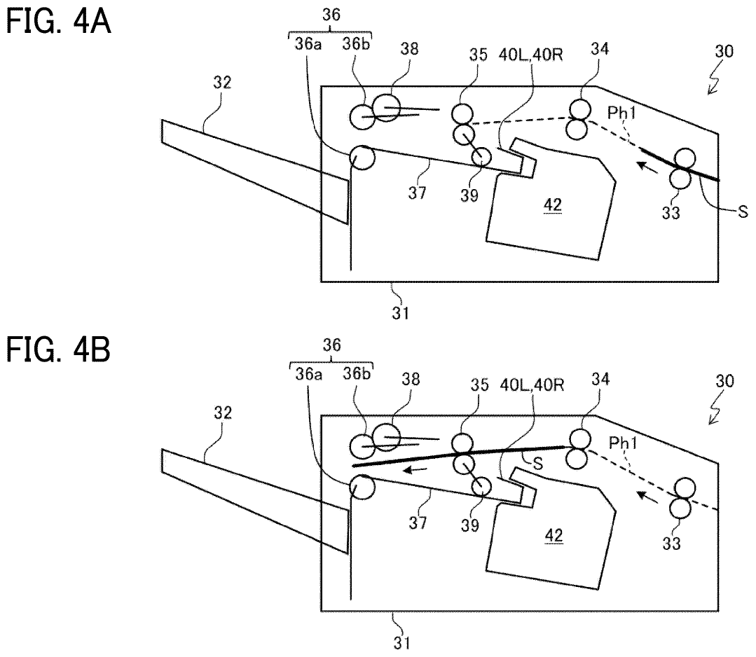

A description is given now of the binding process, with reference to FIGS. 4A to 7B.

FIGS. 4A and 4B are diagrams each illustrating a state of the sheet binder 30 until the sheet S reaches the conveyance roller pair 36.

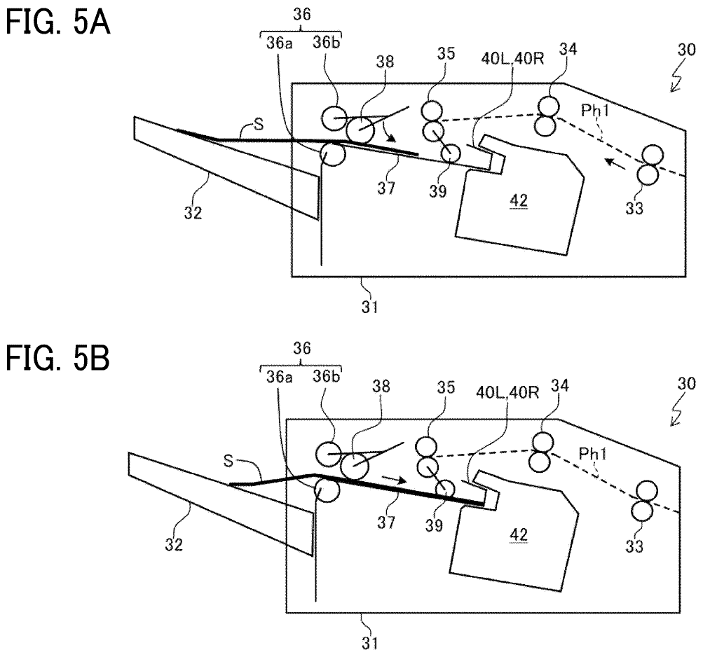

FIGS. 5A and 5B are diagrams each illustrating a state of the sheet binder 30 performing the binding process.

FIG. 6 is a diagram illustrating the sheet binder 30 in the state illustrated in FIG. 5B as viewed from the thickness direction of the sheet S.

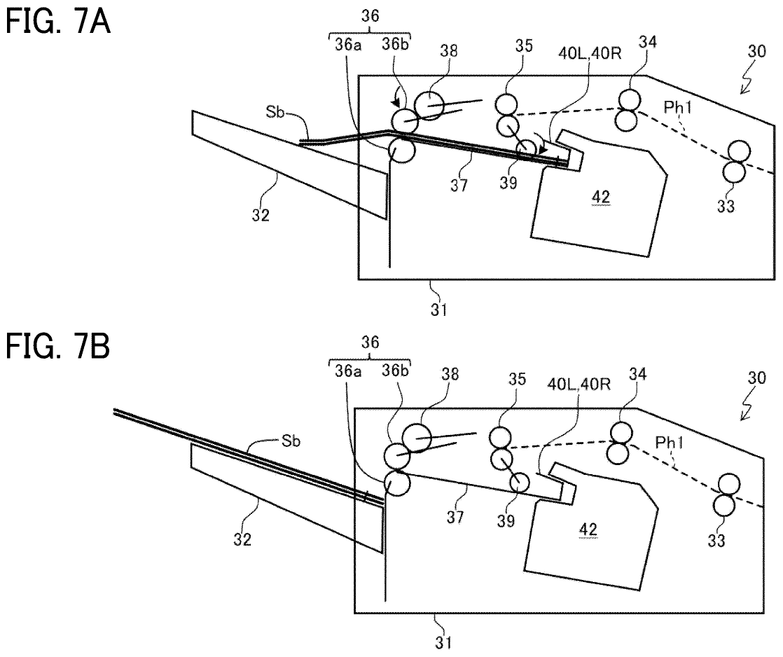

FIGS. 7A and 7B are diagrams illustrating the sheet binder 30 in a state where the sheet bundle Sb subjected to the binding process is discharged to the discharge tray 32.

As illustrated in FIGS. 4A and 4B, the sheet binder 30 rotates the conveyance roller pairs 33 to 35 forward to convey the sheet S supplied from the image forming device 115 along the conveyance path Ph1. At this time, in the conveyance roller pair 36, the driving roller 36a and the driven roller 36b are separated from each other.

As illustrated in FIGS. 5A and 5B, the sheet binder 30 then brings the tapping roller 38 into contact with the sheet S which has passed through the conveyance roller pair 35, and rotates the tapping roller 38 to accommodate the sheet S in the internal tray 37. As illustrated in FIG. 6, the downstream end of the sheet S accumulated in the internal tray 37 in the first conveyance direction contacts the end fences 40L and 40R, and the position of the sheet S in the conveyance direction is aligned. Further, the sheet binder 30 moves the side fences 41L and 41R in the main scanning direction to align the position of the sheet S accommodated in the internal tray 37 in the main scanning direction (so-called jogging). Thus, the sheet binder 30 forms the sheet bundle Sb on the internal tray 37 by repeating the processes illustrated in FIGS. 4A to 6.

As illustrated in FIG. 7A, the sheet binder 30 then causes the binding unit 42 to face the binding position of the sheet bundle Sb in response to a predetermined number of sheets S being laminated on the internal tray 37. Then, the sheet binder 30 performs the press-bonding binding of the sheet bundle Sb supported by the internal tray 37 by driving the binding unit 42. Further, as illustrated in FIG. 7B, the sheet binder 30 causes the conveyance roller pair 36 to discharge the sheet bundle Sb to the discharge tray 32 by reversely rotating the conveyance motor.

### Moving Mechanism of End Fences and Side Fences

FIG. 8 is a plan view of a moving mechanism of the end fences 40L and 40R and the side fences 41L and 41R.

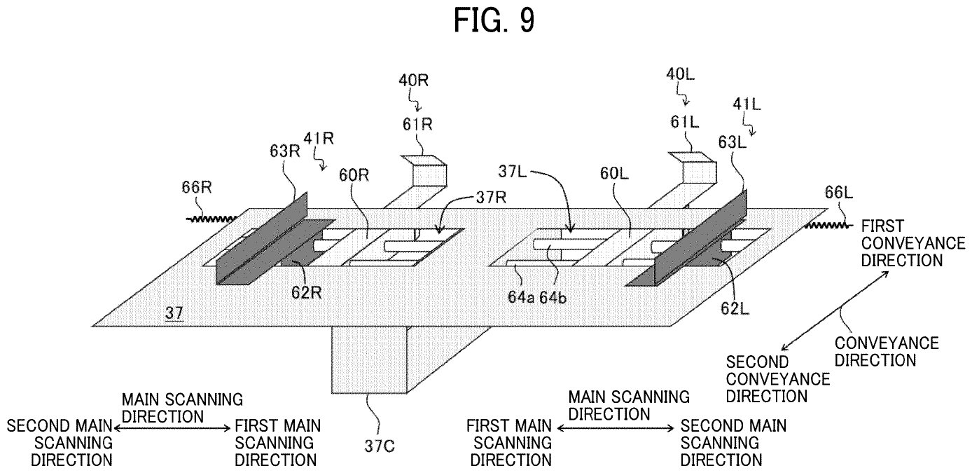

FIG. 9 is a perspective view of the moving mechanism of the end fences 40L and 40R and the side fences 41L and 41R.

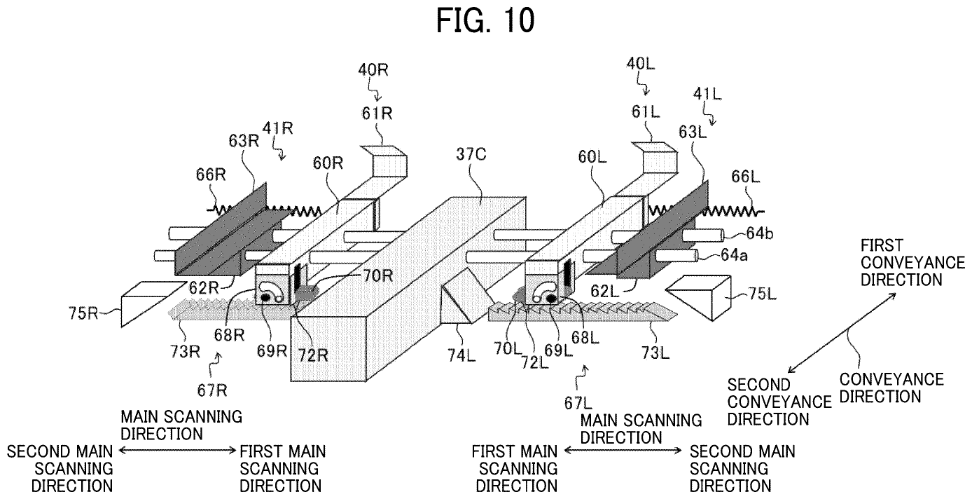

FIG. 10 is a perspective view in which the internal tray 37 is omitted from FIG. 9.

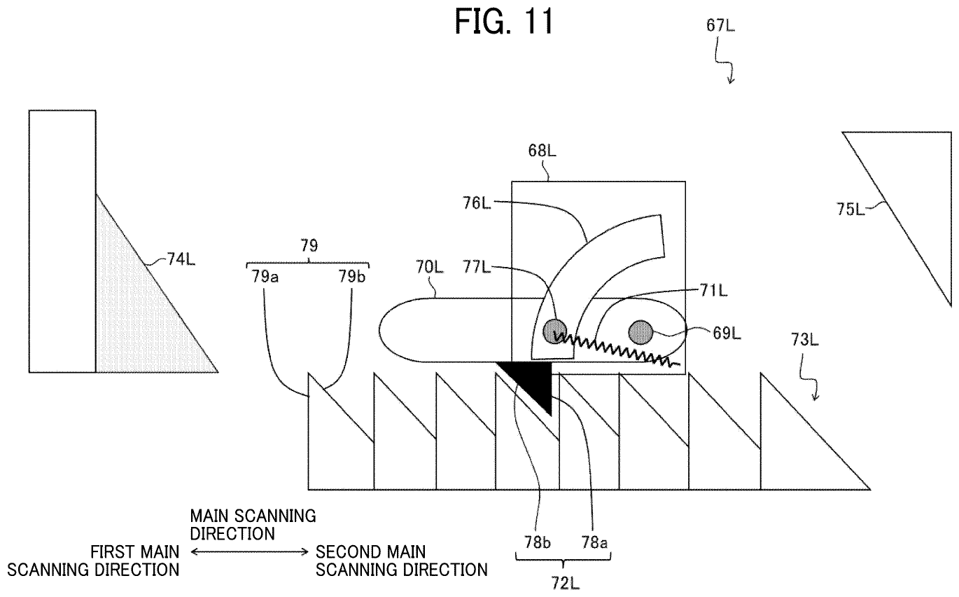

FIG. 11 is an enlarged view of a switching mechanism 67L as a switcher.

As illustrated in FIGS. 8 to 10, the pair of the end fences 40L and 40R is arranged at positions separated from each other in the main scanning direction. More particularly, the pair of the end fences 40L and 40R is arranged on opposite sides across the center in the main scanning direction of the sheet S or the sheet bundle Sb supported by the internal tray 37. The end fences 40L and 40R include guided portions 60L and 60R and alignment portions 61L and 61R. Since the configurations of the end fences 40L and 40R are common, a description is given below of the end fence 40L.

The guided portion 60L is a portion arranged below the internal tray 37. The guided portion 60L is a portion guided by guide rails 64a and 64b (described below). Further, the guided portion 60L is formed with a through hole penetrating in the main scanning direction to allow the guide rails 64a and 64b to pass therethrough.

The alignment portion 61L is a portion arranged on the downstream side of the internal tray 37 in the first conveyance direction. The alignment portion 61L is a portion arranged above the internal tray 37. Further, the alignment portion 61L is a portion that contacts the downstream end in the first conveyance direction of the sheet S or the sheet bundle Sb supported by the internal tray 37 and aligns the positions in the conveyance direction of the plurality of sheets S constituting the sheet bundle Sb.

The pair of the side fences 41L and 41R is arranged at positions separated from each other in the main scanning direction. More particularly, the pair of the side fences 41L and 41R is arranged on opposite sides across the center in the main scanning direction of the sheet S or the sheet bundle Sb supported by the internal tray 37. In addition, the pair of the side fences 41L and 41R is arranged outward of the pair of the end fences 40L and 40R in the main scanning direction (downstream side in the second main scanning direction). The side fences 41L and 41R include guided portions 62L and 62R and alignment portions 63L and 63R. Although the side fences 41L and 41R are reversed in the main scanning direction, the side fence 41L will be described below because the configurations of the side fences 41L and 41R are common.

The guided portion 62L is a portion arranged below the internal tray 37. The guided portion 62L is a portion guided by the guide rails 64a and 64b. Further, the guided portion 62L is formed with a through hole penetrating in the main scanning direction to allow the guide rails 64a and 64b to pass therethrough.

The alignment portion 63L is a portion arranged above the internal tray 37. The alignment portion 63L is a portion that protrudes in the thickness direction of the sheet S or the sheet bundle Sb supported by the internal tray 37 and extends in the conveyance direction. Further, the alignment portion 63L is a portion that contacts the end in the main scanning direction of the sheet S or the sheet bundle Sb supported by the internal tray 37 to align the positions in the main scanning direction of the plurality of sheets S constituting the sheet bundle Sb.

Openings 37L and 37R penetrating in the thickness direction are formed in the internal tray 37. The openings 37L and 37R are set to have sizes that allow the guided portions 62L and 62R to pass therethrough and do not allow the alignment portions 63L and 63R to pass therethrough. Furthermore, the openings 37L and 37R are formed over the entire moving range of the side fences 41L and 41R in the main scanning direction. Further, the internal tray 37 is provided with a support portion 37C. The support portion 37C extends in the conveyance direction on the lower surface of the internal tray 37 at the center in the main scanning direction. The support portion 37C allows the guide rails 64a and 64b to pass therethrough and supports first switching members 74L and 74R to be described below.

Further, the sheet binder 30 includes the guide rails 64a and 64b, fence motors 65L and 65R (see FIG. 17), coil springs 66L and 66R, and switching mechanisms 67L and 67R each as a switcher. These components (64 to 67) play a role of moving the end fences 40L and 40R and the side fences 41L and 41R in the main scanning direction.

The guide rails 64a and 64b are long rod-shaped members. The guide rails 64a and 64b are arranged below the internal tray 37. The guide rails 64a and 64b each extend in the main scanning direction at positions separated from each other in the conveyance direction. The guide rails 64a and 64b are inserted into through holes provided in the support portion 37C and the guided portions 60L, 60R, 62L, and 62R, support the end fences 40L and 40R and the side fences 41L and 41R, and guide the movement of the end fences 40L and 40R and the side fences 41L and 41R in the main scanning direction.

The fence motor 65L is a drive source that generates a driving force for moving the end fence 40L and the side fence 41L in the main scanning direction. The fence motor 65R is a drive source that generates a driving force for moving the end fence 40R and the side fence 41R in the main scanning direction. In other words, the end fence 40L and the side fence 41L, and the end fence 40R and the side fence 41R can be independently moved in the main scanning direction. Here, the end fences 40L and 40R and the side fences 41L and 41R may be moved in conjunction with each other by a single drive source.

The fence motors 65L and 65R can perform forward rotation and reverse rotation in a direction opposite to the forward rotation. The forward rotation is in a direction in which the side fences 41L and 41R are moved in the first main scanning direction. The reverse rotation is in a direction in which the side fences 41L and 41R are moved in the second main scanning direction. On the other hand, whether or not the end fence 40 moves when the side fences 41L and 41R move is switched by the switching mechanisms 67L and 67R.

One end of each of the coil springs 66L and 66R is fixed to the binding case 31, and the other end of each of the coil springs 66L and 66R is fixed to the end fences 40L and 40R. The coil springs 66L and 66R are biasing members that bias the end fences 40L and 40R in the second main scanning direction.

The switching mechanism 67L is a switcher that switches on whether or not to move the end fence 40L in the main scanning direction by the driving force of the fence motor 65L and the biasing force of the coil spring 66L. The switching mechanism 67R is a switcher that switches on whether or not to move the end fence 40R in the main scanning direction by the driving force of the fence motor 65R and the biasing force of the coil spring 66R.

The switching mechanisms 67L and 67R include housings 68L and 68R, support shafts 69L and 69R, arms 70L and 70R, coil springs 71L and 71R, claws 72L and 72R, rack gears 73L and 73R each as a stopper, first switching members 74L and 74R, and second switching members 75L and 75R. Although the switching mechanisms 67L and 67R are reversed in the main scanning direction, the switching mechanism 67L will be described below because the configurations of the switching mechanisms 67L and 67R are common.

The housing 68L is fixed to the guided portion 60L of the end fence 40L. In other words, the housing 68L moves in the main scanning direction together with the end fence 40L. The housing 68L supports the support shaft 69L, the arm 70L, and the coil spring 71L. Further, as illustrated in FIG. 11, a guide groove 76L is formed in the housing 68L. The guide groove 76L is formed in an arc shape centered on the support shaft 69L. The guide groove 76L receives a protrusion 77L provided on the arm 70L and guides the rotation of the arm 70L.

The support shaft 69L is fixed to the housing 68L. The support shaft 69L extends in the conveyance direction. Further, the support shaft 69L rotatably supports a proximal end of the arm 70L. The arm 70L is supported by the housing 68L so as to be rotatable about the support shaft 69L. The arm 70L has the protrusion 77L that protrudes in the main scanning direction and enters the guide groove 76L. Further, the claw 72L is attached to the arm 70L.

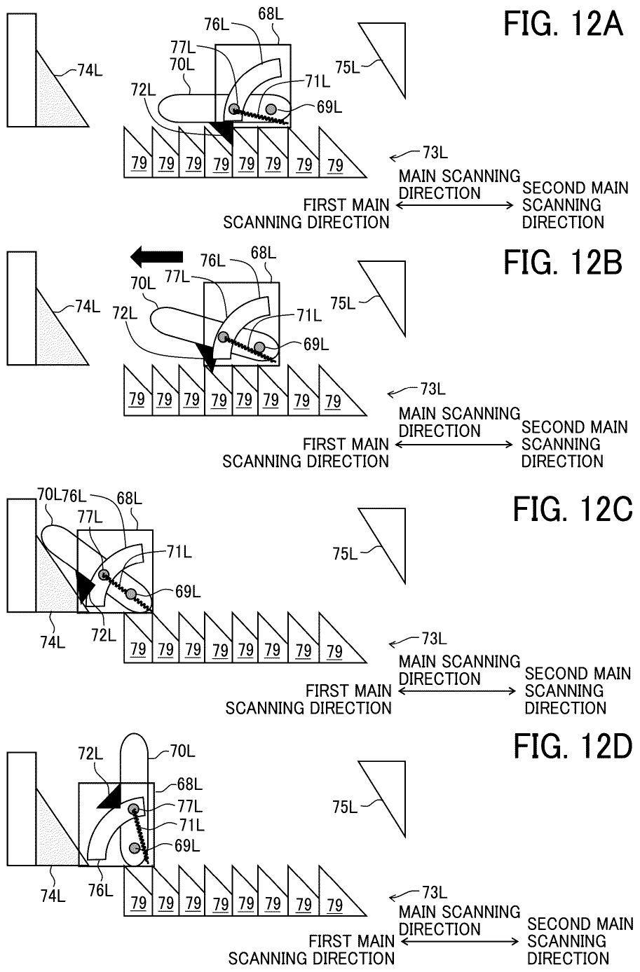

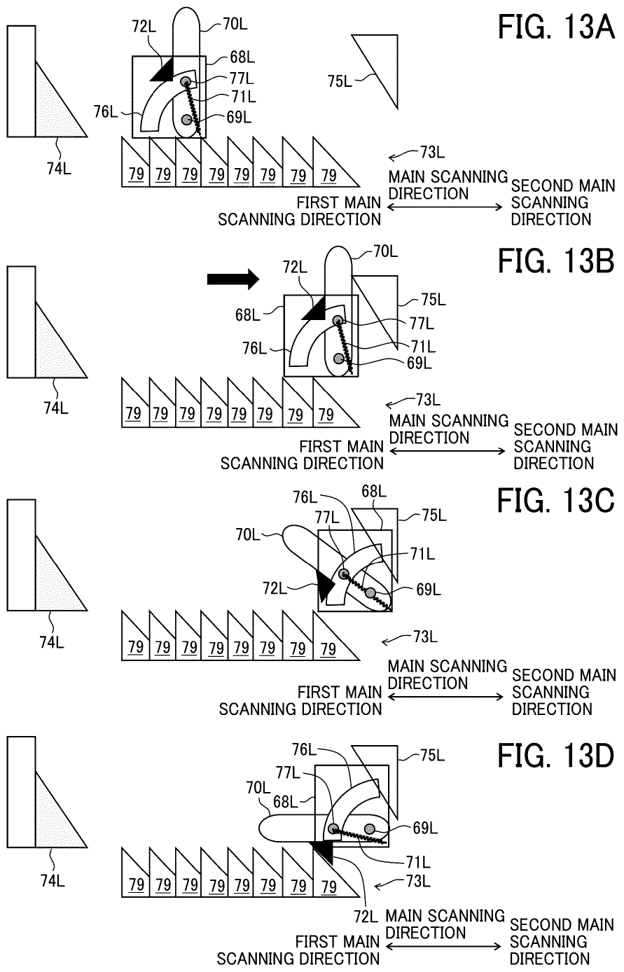

Then, the arm 70L rotates between an engagement posture illustrated in FIGS. 12A and 13D and a release posture illustrated in FIGS. 12D, 13A, and 13B. The engagement posture is a posture of the arm 70L in which the claw 72L and the rack gear 73L are engaged. The release posture is a posture of the arm 70L in which the engagement between the claw 72L and the rack gear 73L is released. Further, as illustrated in FIGS. 12C and 13C, the posture of the arm 70L when one end of the coil spring 71L, the support shaft 69L, and the protrusion 77L are aligned on a straight line is referred to as “neutral posture”. In other words, the neutral posture is a posture between the engagement posture and the release posture.

The coil spring 71L is a biasing member having one end fixed to the housing 68L and the other end fixed to the protrusion 77L of the arm 70L in a state of being extended longer than the natural length. One end of the coil spring 71L is fixed to the housing 68L on a side opposite to the protrusion 77L across the support shaft 69L (in other words, the position where the distance from the protrusion 77L is longer than the support shaft 69L) when the arm 70L is in the neutral posture.

The coil spring 71L biases the arm 70L toward the engagement posture when the arm 70L is in a posture closer to the engagement posture than to the neutral posture. In addition, the coil spring 71L biases the arm 70L toward the release posture when the arm 70L is in a posture closer to the release posture than to the neutral posture. In other words, the coil spring 71L is attached so as to switch the biasing direction in response to the arm 70L passing through the neutral posture.

The claw 72L is attached to the arm 70L and rotates together with the arm 70L. The claw 72L has an orthogonal surface 78a and an inclined surface 78b. The orthogonal surface 78a is orthogonal to the main scanning direction when the arm 70L is in the engagement posture. The inclined surface 78b is inclined with respect to the main scanning direction when the arm 70L is in the engagement posture.

The rack gear 73L is fixed to the binding case 31 at a position facing the claw 72L. The rack gear 73L extends in the main scanning direction. The rack gear 73L further includes a plurality of engaging teeth 79 arranged in a line in the main scanning direction. The engaging tooth 79 has an orthogonal surface 79a and an inclined surface 79b. The orthogonal surface 79a is orthogonal to the main scanning direction. The inclined surface 79b is inclined with respect to the main scanning direction.

When the housing 68L reaches the downstream end in the first main scanning direction together with the end fence 40L, the first switching member 74L contacts the arm 70L to rotate the arm 70L from the engagement posture to the release posture against the biasing force of the coil spring 71L. When the housing 68L reaches the downstream end in the second main scanning direction together with the end fence 40L, the second switching member 75L contacts the arm 70L to rotate the arm 70L from the release posture to the engagement posture against the biasing force of the coil spring 71L.

FIGS. 12A, 12B, 12C and 12D are diagrams illustrating a process in which the switching mechanism 67L is switched from a first state to a second state.

FIGS. 13A, 13B, 13C and 13D are diagrams illustrating a process in which the switching mechanism 67L is switched from the second state to the first state.

As illustrated in FIG. 12A, when the arm 70L is in the engagement posture, the claw 72L is engaged with one of the plurality of engaging teeth 79. More particularly, the orthogonal surfaces 78a and 79a face each other, and the inclined surfaces 78b and 79b face each other. When the fence motor 65L is rotated forward in this state, the side fence 41L moving in the first main scanning direction contacts (comes into contact with) the end fence 40L, and presses the end fence 40L in the first main scanning direction. At this time, as illustrated in FIG. 12B, the end fence 40L moves in the first main scanning direction together with the side fence 41L as the claw 72L rides over the inclined surface 79b of the engagement tooth 79.

On the other hand, when the fence motor 65L is reversely rotated in the state of FIG. 12A, the side fence 41L moving in the second main scanning direction is separated from the end fence 40L. At this time, the end fence 40L is biased to move in the second main scanning direction by the biasing force of the coil spring 66L. However, as the orthogonal surfaces 78a and 79a contact each other, the claw 72L cannot ride over the engaging tooth 79. In other words, the end fence 40L cannot move in the second main scanning direction. In other words, the end fence 40L stops at the current position. The same applies to a case where the side fence 41L moves in the first main scanning direction and the second main scanning direction on the downstream side of the end fence 40L in the second main scanning direction.

The state of the switching mechanism 67L in FIGS. 12A and 12B is the “first state”. In other words, the switching mechanism 67L in the first state allows the end fence 40L to move in the first main scanning direction together with the side fence 41L, and restricts the end fence 40L from moving in the second main scanning direction by the biasing force of the coil spring 66L. In other words, the switching mechanism 67L in the first state moves the end fence 40L, which contacts the side fence 41L that moves in the first main scanning direction, in the first main scanning direction together with the side fence 41L. Furthermore, the switching mechanism 67L in the first state stops the end fence 40L at the current position when the side fence 41L moves on the downstream side of the end fence 40L in the second main scanning direction.

In other words, the end fence 40L can move to an arbitrary position in the main scanning direction by being pushed by the side fence 41L moving in the first main scanning direction when the switching mechanism 67L is in the first state. Furthermore, the end fence 40L can stay at the current position when the side fence 41L moves in the first main scanning direction and the second main scanning direction on the downstream side of the end fence 40L in the second main scanning direction when the switching mechanism 67L is in the first state.

On the other hand, as illustrated in FIG. 13A, when the arm 70L is in the release posture, the claw 72L is not engaged with any of the plurality of engaging teeth 79. However, when the side fence 41L is in contact with the end fence 40L, the side fence 41L cannot move in the second main scanning direction by the biasing force of the coil spring 66L. When the fence motor 65L is reversely rotated in this state, the side fence 41L moving in the second main scanning direction is separated from the end fence 40L. At this time, as illustrated in FIG. 13B, the end fence 40L moves in the second main scanning direction by the biasing force of the coil spring 66L.

The state of the switching mechanism 67L in FIGS. 13A and 13B is the “second state”. In other words, the switching mechanism 67L in the second state allows the end fence 40L to move in the first main scanning direction together with the side fence 41L. In addition, the switching mechanism 67L in the second state allows the end fence 40L to move in the second main scanning direction by the biasing force of the coil spring 66L when the side fence 41L is separated from the end fence 40L.

Furthermore, as illustrated in FIGS. 12C and 12D, when the end fence 40L reaches the downstream end in the first main scanning direction, the arm 70L contacts the first switching member 74L, and changes the posture from the engagement posture to the release posture. In other words, the switching mechanism 67L is switched from the first state to the second state. Furthermore, as illustrated in FIGS. 13C and 13D, when the end fence 40L reaches the downstream end in the second main scanning direction, the arm 70L contacts the second switching member 75L, and changes the posture from the release posture to the engagement posture. In other words, the switching mechanism 67L is switched from the second state to the first state.

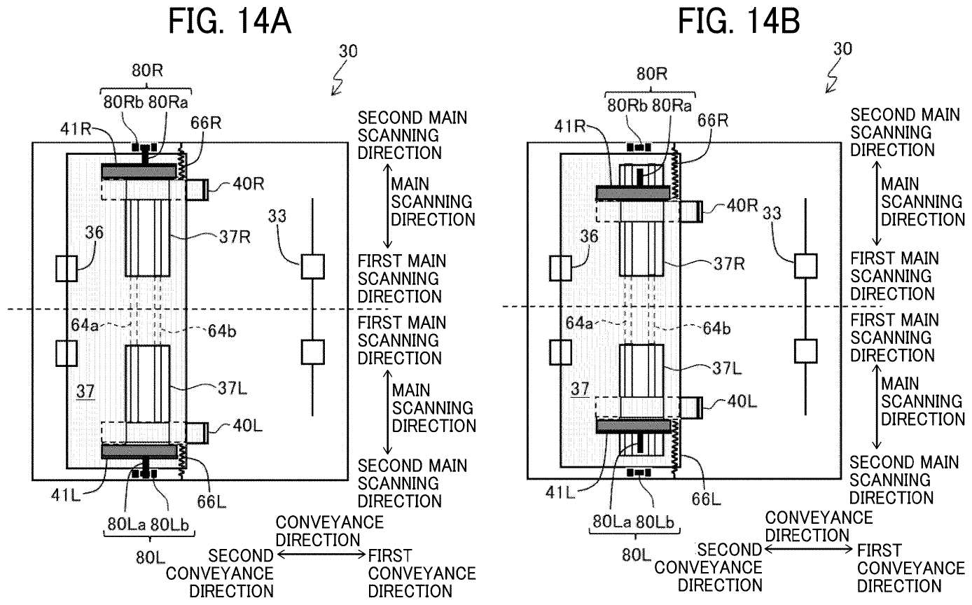

FIGS. 14A and 14B are diagrams each illustrating an example of arrangement of position sensors 80L and 80R.

As illustrated in FIGS. 14A and 14B, the sheet binder 30 includes the position sensors 80L and 80R. The position sensors 80L and 80R detect that the end fences 40L and 40R are arranged at home positions in the main scanning direction. The home position is, for example, a position of a downstream end in the second main scanning direction. The specific configurations of the position sensors 80L and 80R are not particularly limited, and for example, a mechanical sensor, an optical sensor, or a magnetic sensor can be adopted.

The position sensors 80L and 80R include, for example, fillers 80La and 80Ra and detection elements 80Lb and 80Rb. The fillers 80La and 80Ra are attached to the end fences 40L and 40R, and move in the main scanning direction together with the end fences 40L and 40R. The detection elements 80Lb and 80Rb are arranged at positions where the fillers 80La and 80Ra can be detected when the end fences 40L and 40R are at home positions.

As illustrated in FIG. 14A, when the end fences 40L and 40R are arranged at the home positions, the detection elements 80Lb and 80Rb detect the fillers 80La and 80Ra. At this time, the position sensors 80L and 80R output position signals to the controller 160. On the other hand, as illustrated in FIG. 14B, when the end fences 40L and 40R are arranged at positions different from the home positions, the detection elements 80Lb and 80Rb do not detect the fillers 80La and 80Ra. At this time, the position sensors 80L and 80R stop outputting position signals.

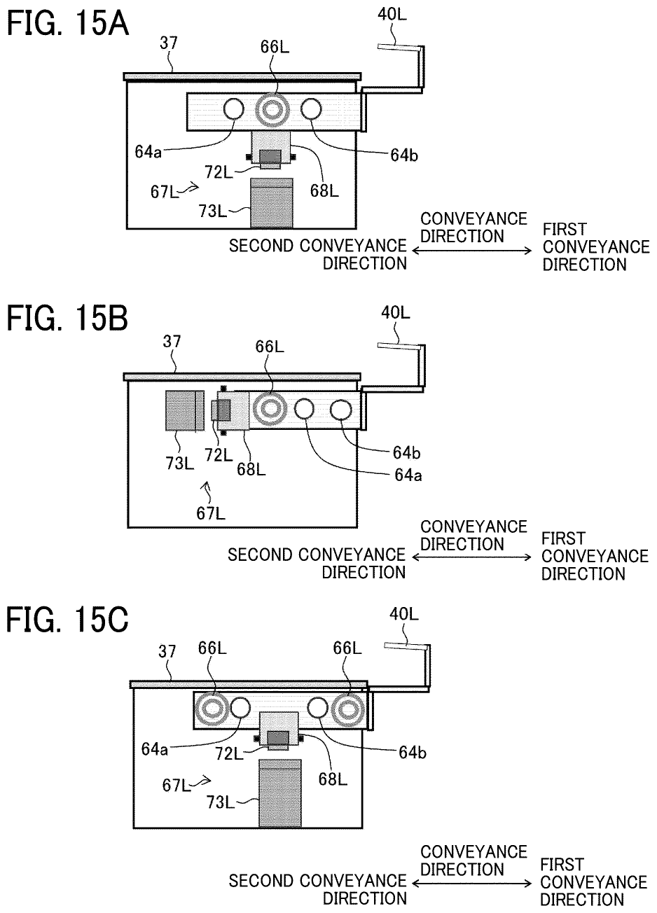

FIGS. 15A to 15C are diagrams each illustrating a variation of a positional relationship between the coil spring 66L and the switching mechanism 67L.

As illustrated in FIGS. 15A to 15C, it is preferable to arrange the coil spring 66L and the switching mechanism 67L in a positional relationship which can suppress the inclination of the end fence 40L when the end fence 40L moves in the main scanning direction. Here, the positional relationship between the coil spring 66L and the switching mechanism 67L is not limited to the example of FIGS. 15A to 15C.

As an example, as illustrated in FIG. 15A, the coil spring 66L may be arranged between the guide rails 64a and 64b in the conveyance direction. Further, the switching mechanism 67L may be arranged at the same position in the conveyance direction with respect to the coil spring 66L and at a position shifted in the thickness direction of the sheet S or the sheet bundle Sb accumulated in the internal tray 37. Further, the claw 72L and the rack gear 73L may face each other in the thickness direction of the sheet S or the sheet bundle Sb accumulated in the internal tray 37.

As another example, as illustrated in FIG. 16B, the coil spring 66L may be arranged on the downstream side of the guide rails 64a and 64b in the second conveyance direction. The switching mechanism 67L may be arranged on the downstream side of the coil spring 66L in the second conveyance direction. In other words, the switching mechanism 67L may be arranged on the side opposite to the guide rails 64a and 64b across the coil spring 66L in the conveyance direction. Further, the claw 72L and the rack gear 73L may face each other in the conveyance direction.

As still another example, the coil spring 66L may be arranged at two positions of the downstream side of the guide rails 64a and 64b in the first conveyance direction and the downstream side of the guide rails 64a and 64b in the second conveyance direction. The switching mechanism 67L may be arranged between the guide rails 64a and 64b in the conveyance direction. In other words, the switching mechanism 67L may be arranged between the two coil springs 66L in the conveyance direction. Further, the claw 72L and the rack gear 73L may face each other in the thickness direction of the sheet S or the sheet bundle Sb accumulated in the internal tray 37.

FIG. 16 is a diagram illustrating another example of FIG. 8.

For example, as illustrated in FIG. 16, the sheet binder 30 may be configured such that the end fence 40L and the side fence 41L are fixed, and the end fence 40R and the side fence 41R are movable in the main scanning direction. The sheet binder 30 illustrated in FIG. 16 is different from the example of FIG. 8 in that the components for moving the end fence 40L and the side fence 41L in the main scanning direction are omitted, and is similar to the example of FIG. 8 in other aspects. Here, the sheet binder 30 may be configured such that the end fence 40R and the side fence 41R are fixed, and the end fence 40L and the side fence 41L are movable in the main scanning direction.

### Hardware Configuration of Image Forming Apparatus

FIG. 17 is an example of a hardware configuration diagram of the image forming apparatus 1.

As illustrated in FIG. 17, the image forming apparatus 1 includes the controller 150 (control unit) that controls the operation of the main body of the image forming apparatus 1, and the controller 160 (control unit) that controls the operation of the sheet binder 30. The controllers 150 and 160 cooperatively control the operation of the image forming apparatus 1.

The controllers 150 and 160 include, for example, central processing units (CPUs) 151 and 161 and memories 152 and 162. The memories 152 and 162 include, for example, a read only memory (ROM), a random access memory (RAM), a hard disk drive (HDD), or a combination of ROM, RAM and HDD. The controllers 150 and 160 implement a process to be described below by the CPUs 151 and 161 reading and executing program codes stored in the memories 152 and 162. Here, the specific configurations of the controllers 150 and 160 are not limited thereto, and may be implemented by hardware such as an application specific integrated circuit (ASIC) and a field-programmable gate array (FPGA).

The controller 150 controls operation of the components (for example, the sheet feed roller 197, the image forming device 115, the fixing device 120, the conveyance roller pairs 131 and 132, and the control panel 149) of the main body of the image forming apparatus 1 through an internal interface (IF) 153. The controller 160 controls operation of the components (for example, the conveyance roller pairs 33 to 36, the tapping roller 38, the return roller 39, the end fences 40L and 40R, the side fences 41L and 41R, the binding unit 42, the position sensors 53, 80L, 80R, 81L, and 81R, rotary encoders 47a, 56a, 65La, and 65Ra) of the sheet binder 30 through an internal IF 163. Although merely main motors and sensors of the present disclosure are illustrated in FIG. 17, each component is driven by a motor (drive source), and an operation state (position, posture) is detected by sensors.

The control panel 149 includes an operation unit that receives operations from a user and a display (notification unit) that notifies the user of information. The operation unit includes, for example, physical input buttons, and a touch panel overlaid on the display. The control panel 149 acquires information from an operator through the operation unit and provides the operator with information through the display. A specific example of the notification unit is not limited to the display and may be, for example, a light-emitting diode (LED) lamp, or a speaker.

The rotary encoders 47a, 56a, 65La, and 65Ra detect drive amounts (rotation amounts) of the main scanning motor 47, the rotation motor 56, and the fence motors 65L and 65R. More particularly, the rotary encoders 47a, 56a, 65La, and 65Ra output pulse signals to the controller 160 along with the rotation of the corresponding motors 47, 56, 65L, and 65R. Then, the controller 160 can grasp the drive amounts of the corresponding motors 47, 56, 65L, and 65R by counting the pulse signals output from the rotary encoders 47a, 56a, 65La, and 65Ra.

Furthermore, the controller 160 can grasp the current positions of the end fences 40L and 40R in the main scanning direction by combining the detection results of the position sensors 80L and 80R and the detection results of the rotary encoders 65La and 65Ra. In other words, the position sensors 80L and 80R and the rotary encoders 65La and 65Ra may be combined to serve as position sensors that detect the positions of the end fences 40L and 40R in the main scanning direction.

More particularly, when the fence motors 65L and 65R are rotating forward, the controller 160 adds (accumulates) the pulse signals output from the rotary encoders 65La and 65Ra to variables on the memory 162. When the position signals are output from the position sensors 80L and 80R, the controller 160 initializes (assigns a value of 0 to) the variables on the memory 162. Then, the controller 160 specifies the current positions of the end fences 40L and 40R based on the accumulated values of the pulse signals stored in the variables on the memory 162.

The position sensors 81L and 81R detect that the side fences 41L and 41R are arranged at home positions in the main scanning direction. The home position is, for example, a position of a downstream end in the second main scanning direction. For example, the position sensors 81L and 81R output position signals to the controller 160 when the side fences 41L and 41R are arranged at the home positions, and stop outputting position signals when the side fences 41L and 41R are arranged at positions different from the home positions. The specific configurations of the position sensors 81L and 81R are not particularly limited, and for example, a mechanical sensor, an optical sensor, or a magnetic sensor can be adopted.

Furthermore, the controller 160 can grasp the current positions of the side fences 41L and 41R in the main scanning direction by combining the detection results of the position sensors 81L and 81R and the detection results of the rotary encoders 65La and 65Ra. In other words, the side fences 41L and 41R and the rotary encoders 65La and 65Ra may be combined to serve as position sensors that detect the positions of the side fences 41L and 41R in the main scanning direction.

More particularly, when the fence motors 65L and 65R are rotating forward, the controller 160 adds (accumulates) the pulse signals output from the rotary encoders 65La and 65Ra to the variables on the memory 162. The controller 160 subtracts the pulse signals output from the rotary encoders 65La and 65Ra from the variables on the memory 162 when the fence motors 65L and 65R are rotating reversely. When the position signals are output from the position sensors 81L and 81R, the controller 160 initializes (assigns a value of 0 to) the variables on the memory 162. Then, the controller 160 specifies the current positions of the side fences 41L and 41R based on the accumulated values of the pulse signals stored in the variables on the memory 162.

Further, the controllers 150 and 160 are communicably connected to each other through external IFs 154 and 164. The controllers 150 and 160 cooperatively control the operation of each component based on the information transmitted and received through the external IFs 154 and 164.

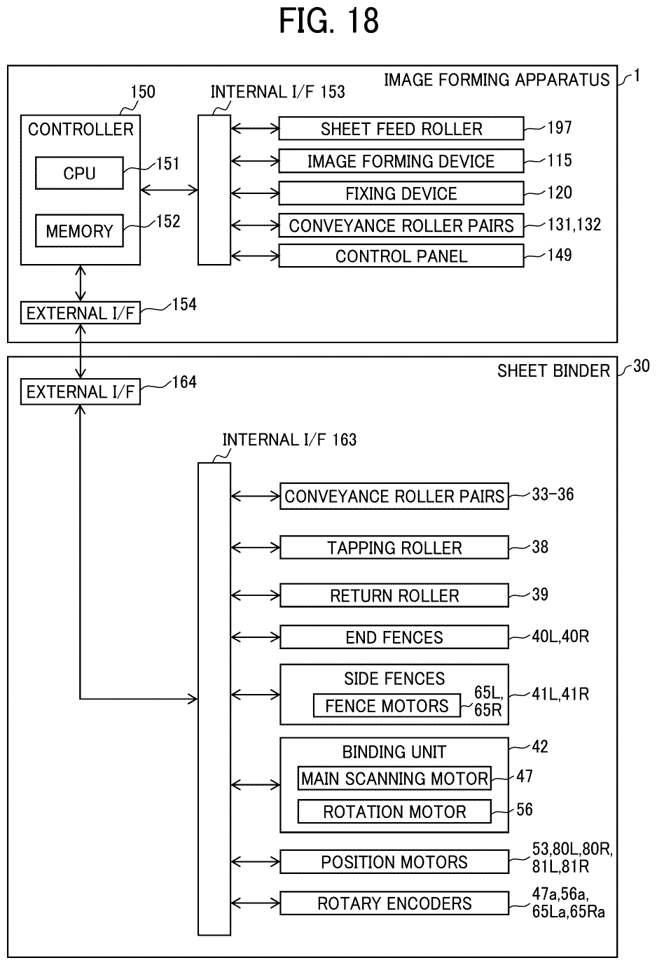

FIG. 18 is another example of the hardware configuration diagram of the image forming apparatus 1.

FIG. 18 is different from FIG. 17 in that the controller 160 of the sheet binder 30 is omitted, and is the same as FIG. 17 in other aspects. The controller 150 illustrated in FIG. 18 controls the operation of the components of the main body of the image forming apparatus 1 through the internal IF 153, and controls the operation of the components of the sheet binder 30 through the external IFs 154 and 164 and the internal IF 163. In other words, the sheet binder 30 illustrated in FIG. 18 operates under the control of the controller 150 mounted on the main body of the image forming apparatus 1.

### Binding Control Process

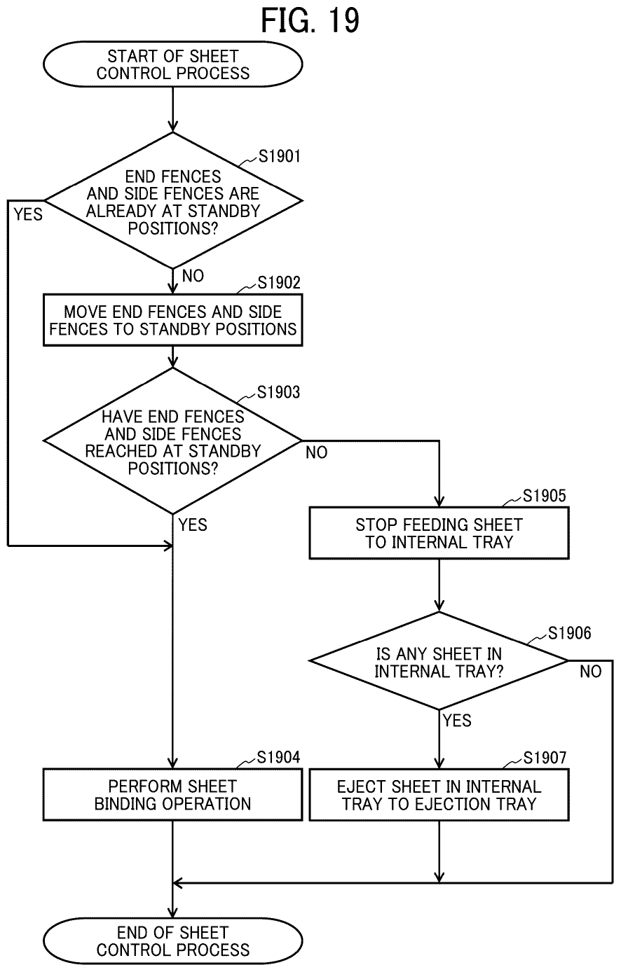

FIG. 19 is a flowchart of a binding control process according to the first embodiment.

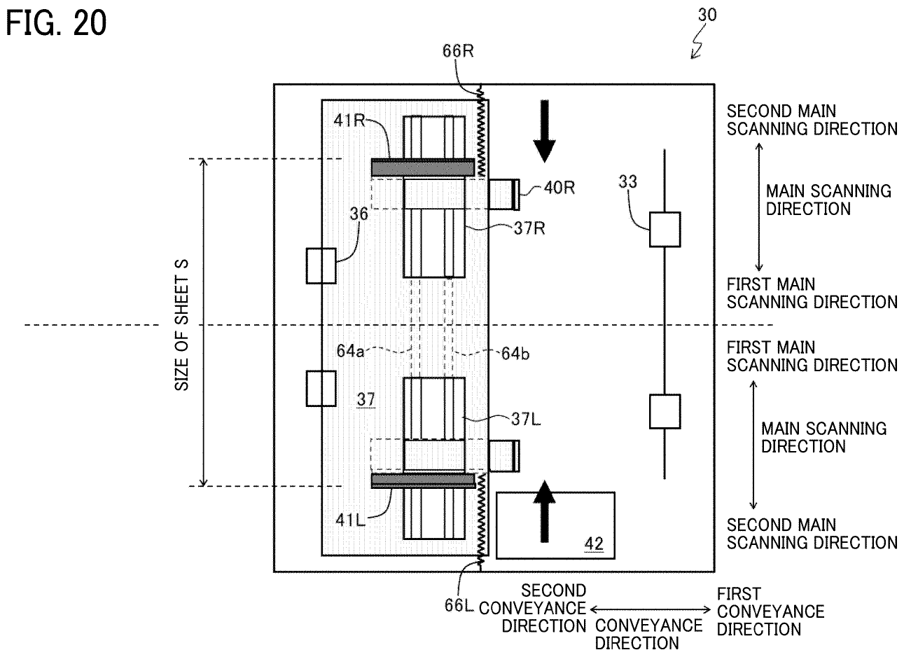

FIG. 20 is a diagram illustrating a state in which the end fences 40L and 40R are moved to standby positions.

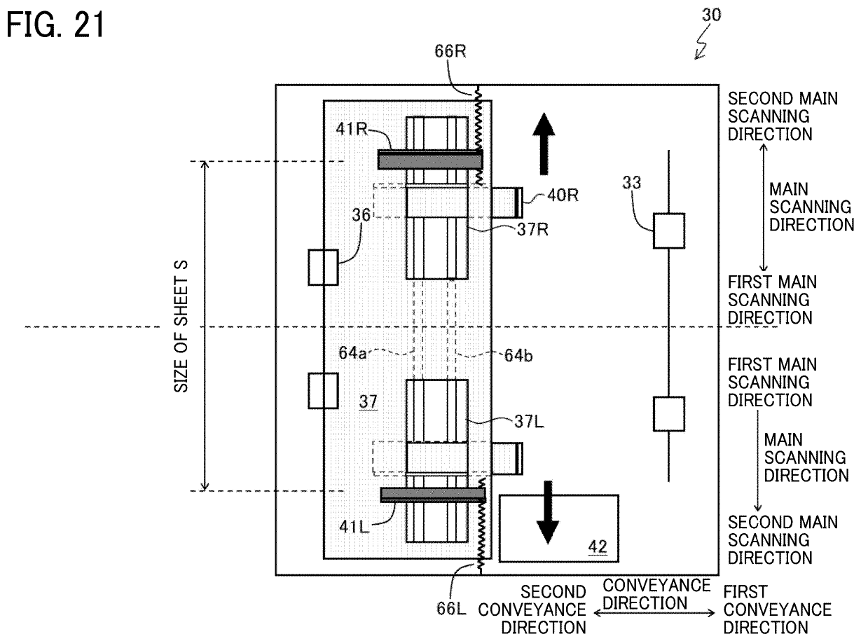

FIG. 21 is a diagram illustrating a state in which the side fences 41L and 41R are moved to standby positions.

The binding control process is a process of binding the sheet bundle Sb supported by the internal tray 37 at the binding position. The binding position is a position on the sheet bundle Sb bound by the binding unit 42.

For example, the controller 150 repeatedly executes a process of forming an image on the sheet S accommodated in the sheet tray 112 and supplying the sheet S to the sheet binder 30 in accordance with a user's instruction through the control panel 149 (or an instruction from an external device). The controller 150 outputs the binding information to the controller 160 through the external IF 154 prior to the above-described process (or in parallel with the above-described process). The binding information output by the controller 150 may be, for example, a default setting stored in the memory 152, a setting input by the user through the control panel 149, or a setting instructed from an external device.

The binding information includes, for example, at least the number of sheets S constituting the sheet bundle Sb, and the positions (coordinates on the sheet bundle Sb) and number of the binding positions on the sheet bundle Sb. Further, the binding information may include, for example, size information indicating the size of the sheet S. As an example, the size information may be a combination of the size (for example, A4, B4) of the sheet S and the orientation (for example, vertical orientation, horizontal orientation) of the sheet S. As another example, the size information may be the length in the main scanning direction of the sheet S. In other words, the size information may be any information as long as the size (length) in the main scanning direction of the sheet S supported by the internal tray 37 can be specified.

In addition, the memory 162 stores the standby positions of the end fences 40L and 40R and the side fences 41L and 41R in association with the size in the main scanning direction of the sheet S that can be supported by the internal tray 37. The standby positions are positions in the main scanning direction at which the end fences 40L and 40R and the side fences 41L and 41R should stand by when the sheet S is supplied to the internal tray 37. As another example, the binding information may include position information indicating the standby positions of the end fences 40L and 40R and the side fences 41L and 41R instead of the size information.

The standby positions of the end fences 40L and 40R are positions closer to the center than the ends in the main scanning direction of the sheets S accumulated in the internal tray 37. In other words, the interval in the main scanning direction between the end fences 40L and 40R at the standby positions is shorter than the length in the main scanning direction of the sheets S accumulated in the internal tray 37. The standby positions of the side fences 41L and 41R are positions slightly outward of (opposite to the center in the main scanning direction) the ends in the main scanning direction of the sheets S. In other words, the interval in the main scanning direction between the side fences 41L and 41R at the standby positions is longer than the length in the main scanning direction of the sheets S accumulated in the internal tray 37.

The controller 160 starts the binding control process in response to acquisition of the binding information from the controller 150 through the external IF 164. On the other hand, in the case of the hardware configuration illustrated in FIG. 18, the controller 150 executes the binding control process. It is assumed that the arms 70L and 70R are at engagement positions (in other words, the switching mechanisms 67L and 67R are in the first state) at the start of the binding control process.

First, the controller 160 determines whether or not the end fences 40L and 40R and the side fences 41L and 41R are already arranged at the standby positions (step S1901). In other words, the controller 160 may compare the standby positions corresponding to the size in the main scanning direction of the sheet S indicated by the size information with the current positions of the end fences 40L and 40R and the side fences 41L and 41R indicated by the accumulated values of the pulse signals stored in the memory 162.

Then, when the controller 160 has determined that the current positions of the end fences 40L and 40R are different from the standby positions (step S1901: No), by rotating the fence motors 65L and 65R before executing the binding process (step S1904), the controller 160 moves the end fences 40L and 40R and the side fences 41L and 41R to the standby positions corresponding to the size in the main scanning direction of the sheet S (step S1902).

As an example, in a case where the current positions of the end fences 40L and 40R are outward of the standby positions (on the downstream side in the second main scanning direction), the controller 160 rotates the fence motors 65L and 65R forward to move the end fences 40L and 40R to the standby positions as illustrated in FIG. 20. Then, as illustrated in FIG. 21, the controller 160 rotates the fence motors 65L and 65R reversely to move the side fences 41L and 41R to the standby positions. The case where the current positions of the end fences 40L and 40R are outward of the standby positions is, for example, a case where the end fences 40L and 40R are arranged at the home positions, or a case where the size of the current sheet S in the main scanning direction is smaller than the size of the previous sheet S.

As another example, in a case where the current positions of the end fences 40L and 40R are inward (on the downstream side in the first main scanning direction) of the standby positions, the controller 160 rotates the fence motors 65L and 65R forward to switch the arms 70L and 70R to the release posture (switch the switching mechanisms 67L and 67R to the second state), and then rotates the fence motors 65L and 65R reversely to switch the arms 70L and 70R to the engagement posture (switch the switching mechanisms 67L and 67R to the first state) again. Then, the controller 160 rotates the fence motors 65L and 65R forward to move the end fences 40L and 40R to the standby positions, and then rotates the fence motors 65L and 65R reversely to move the side fences 41L and 41R to the standby positions. The case where the current positions of the end fences 40L and 40R are inward of the standby positions is, for example, a case where the size of the current sheet S in the main scanning direction is larger than the size of the previous sheet S.

Further, when the controller 160 has determined that the end fences 40L and 40R are already arranged at the standby positions and the side fences 41L and 41R are not arranged at the standby positions, the controller 160 may move the side fences 41L and 41R to the standby positions by rotating the fence motors 65L and 65R.

The controller 160 then determines whether or not all of the end fences 40L and 40R and the side fences 41L and 41R have reached the standby positions (step S1903). In other words, the controller 160 determines whether or not the current positions of the end fences 40L and 40R and the side fences 41L and 41R indicated by the accumulated values of the pulse signals stored in the memory 162 coincide with the standby positions.

Then, when the controller 160 has determined that all of the end fences 40L and 40R and the side fences 41L and 41R have reached the standby positions (step S1903: Yes), the controller 160 executes the binding process described with reference to FIGS. 4A to 7B (step S1904) and ends the binding control process. Further, when the controller 160 has determined that the end fences 40L and 40R and the side fences 41L and 41R are already arranged at the standby positions (step S1901: Yes), the controller 160 skips the processes of steps S1902 to S1903, and executes the process of step S1904.

In other words, in step S1904, the controller 160 accumulates the plurality of sheets S which has passed through the image forming device 115 in the internal tray 37. Every time the sheet S is supplied to the internal tray 37, the controller 160 uses the end fences 40L and 40R at the standby positions to align the position of the sheet S in the conveyance direction, and causes the side fences 41L and 41R at the standby positions to jog to align the position of the sheet S in the main scanning direction. The controller 160 causes the binding unit 42 to bind the binding position of the sheet bundle Sb accumulated in the internal tray 37. The controller 160 rotates the conveyance roller pair 36 to discharge the sheet bundle Sb bound at the binding position to the discharge tray 32.

When the controller 160 has determined that at least part of the end fences 40L and 40R and the side fences 41L and 41R have not reached the standby positions (step S1903: No), the controller 160 stops the supply of the sheet S which has passed through the image forming device 115 to the internal tray 37 (step S1905). In other words, the controller 160 directly discharges the sheet S which has passed through the image forming device 115 to the discharge tray 32.

Further, the controller 160 determines whether or not the sheet S already exists on the internal tray 37 (step S1906). When the controller 160 has determined that the sheet S already exists on the internal tray 37 (step S1906: Yes), the controller 160 rotates the conveyance roller pair 36 to discharge the sheet S supported by the internal tray 37 to the discharge tray 32 (step S1907), and ends the binding control process. On the other hand, when the controller 160 has determined that the sheet S does not exist on the internal tray 37 (step S1906: No), the controller 160 skips the process of step S1907 and ends the binding control process.

### Process of Moving to Home Positions

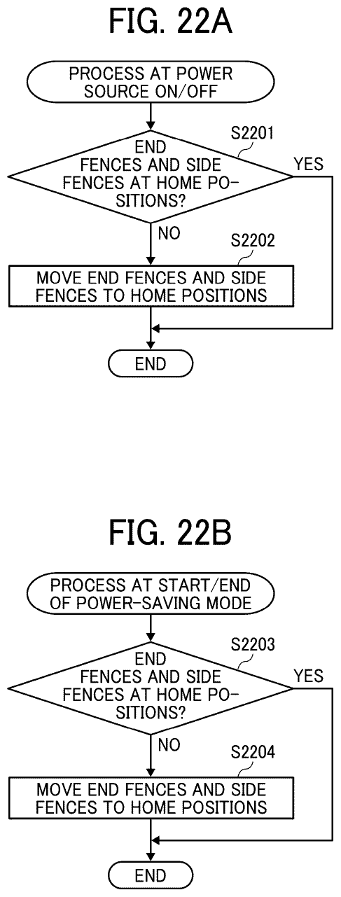

FIGS. 22A and 22B are flowcharts of moving the end fences 40L and 40R and the side fences 41L and 41R to the home positions.

More particularly, FIG. 22A is a flowchart of moving the end fences 40L and 40R and the side fences 41L and 41R to the home positions when the power is turned on or off. FIG. 22B is a flowchart of moving the end fences 40L and 40R and the side fences 41L and 41R to the home positions at the time of starting or ending of an energy-saving mode.

First, the sheet binder 30 (image forming apparatus 1) operates by receiving power supplied from an external power source. In addition, the sheet binder 30 (image forming apparatus 1) is switchable between a power-on state in which power is supplied from an external power source and a power-off state in which power is not supplied from an external power source. The sheet binder 30 (image forming apparatus 1) is switched from one of the power-on state and the power-off state to the other of the power-on state and the power-off state, for example, through an operation of a power switch by a user.

The switching from the power-on state to the power-off state corresponds to the stop of the power supply to the sheet binder 30. For example, when the condition for switching to the power-off state is satisfied, the controller 160 may execute the process of FIG. 22A and then shift to the power-off state. The switching from the power-off state to the power-on state corresponds to the start of the power supply to the sheet binder 30. For example, when the condition for switching to the power-on state is satisfied, the controller 160 may execute the process of FIG. 22A after shifting to the power-on state.

Then, when the sheet binder 30 is switched from one of the power-on state and the power-off state to the other of the power-on state and the power-off state, the controller 160 determines whether or not the end fences 40L and 40R and the side fences 41L and 41R are arranged at the home positions (step S2201). In other words, the controller 160 may determine whether or not position signals are output from the position sensors 80L, 80R, 81L, and 81R.

When the controller 160 has determined that the end fences 40L and 40R and the side fences 41L and 41R are not arranged at the home positions (step S2201: No), the controller 160 moves the end fences 40L and 40R and the side fences 41L and 41R to the home positions (step S2202). More particularly, the controller 160 may rotate the fence motors 65L and 65R forward to switch the arms 70L and 70R to the release posture (switch the switching mechanisms 67L and 67R to the second state), and then rotate the fence motors 65L and 65R reversely to move the end fences 40L and 40R and the side fences 41L and 41R to the home positions. On the other hand, when the controller 160 has determined that the end fences 40L and 40R and the side fences 41L and 41R are arranged at the home positions (step S2201: Yes), the controller 160 skips the process of step S2202.

Further, the sheet binder 30 may be switchable between a normal mode and the energy-saving mode. The normal mode refers to, for example, a state in which power is supplied to the entire sheet binder 30 and the binding control process can be immediately executed. The energy-saving mode refers to, for example, a state in which power is supplied merely to a part (for example, the controller 160) of the sheet binder 30 and power is not supplied to the other parts of the sheet binder 30. The sheet binder 30 in the normal mode is switched to the energy-saving mode, for example, when the sheet binder 30 does not continuously operate for a predetermined time (for example, when the sheet S is not supplied from the image forming device 115). Further, the sheet binder 30 in the energy-saving mode is switched to the normal mode, for example, when the controller 160 has acquired binding information.

The switching from the normal mode to the energy-saving mode corresponds to the start of the energy-saving mode. For example, when the condition for switching to the energy-saving mode is satisfied, the controller 160 may execute the process of FIG. 22B and then shift to the energy-saving mode. The switching from the energy-saving mode to the normal mode corresponds to the end of the energy-saving mode. For example, when the condition for switching to the normal mode is satisfied, the controller 160 may execute the process of FIG. 22B after shifting to the normal mode.

Then, when the sheet binder 30 is switched from one of the normal mode and the energy-saving mode to the other of the normal mode and the energy-saving mode, the controller 160 determines whether or not the end fences 40L and 40R and the side fences 41L and 41R are arranged at the home positions (step S2203). When the controller 160 has determined that the end fences 40L and 40R and the side fences 41L and 41R are not arranged at the home positions (step S2203: No), the controller 160 moves the end fences 40L and 40R and the side fences 41L and 41R to the home positions (step S2204). On the other hand, when the controller 160 has determined that the end fences 40L and 40R and the side fences 41L and 41R are arranged at the home positions (step S2203: Yes), the controller 160 skips the process of step S2204. The processes of steps S2203 to S2204 are similar to those of steps S2201 to S2202.

### Effects of First Embodiment

According to the first embodiment, the end fence 40R can be moved in the first main scanning direction by pushing the end fence 40R with the side fence 41R. Furthermore, the side fence 41R can be moved on the downstream side of the end fence 40R in the second main scanning direction in a state where the end fence 40R is kept at the current position. As a result, the end fence 40R can be arranged at a position corresponding to the size of the sheet S, and the end fence 40R can be prevented from moving at the time of jogging of the side fence 41R. As a result, it is possible to suppress deterioration in quality of the sheet bundle Sb bound by the sheet binder 30. The same applies to the end fence 40L and the side fence 41L in the form of FIG. 8. The same applies to the following effects as well.

Furthermore, according to the first embodiment, by enabling the switching mechanism 67R to switch between the first state and the second state, the end fence 40R can be arranged at an arbitrary position in the main scanning direction. As a result, the positions of the sheets S of various sizes in the conveyance direction can be appropriately aligned.

Furthermore, according to the first embodiment, the switching mechanism 67R is switched from the first state to the second state by causing the end fence 40R to reach the downstream end in the first main scanning direction, and the switching mechanism 67R is switched from the second state to the first state by causing the end fence 40R to reach the downstream end in the second main scanning direction. As a result, the state of the switching mechanism 67R can be switched with a simple process.

Furthermore, according to the first embodiment, by changing the standby positions of the end fence 40R and the side fence 41R based on the size information acquired from the controller 150, the end fence 40R and the side fence 41R can be arranged at positions suitable for the size of the sheet S.

According to the first embodiment, the end fence 40R and the side fence 41R are moved to the standby positions before the first sheet S constituting the sheet bundle Sb is accumulated in the internal tray 37 (more preferably, before the first sheet S is supplied to the sheet binder 30), whereby the productivity of the sheet binder 30 is improved.

Furthermore, according to the first embodiment, by returning the end fence 40R and the side fence 41R to the home positions at the time of switching the power on or off or at the time of starting or ending the energy-saving mode, the end fence 40R can be moved to a desired standby position simply through rotating the fence motor 65R forward (in other words, the process of switching the switching mechanism 67R to the second state and then switching the switching mechanism 67R to the first state is omitted) in step S1902. Accordingly, the productivity of the binding control process is improved.

### SECOND EMBODIMENT

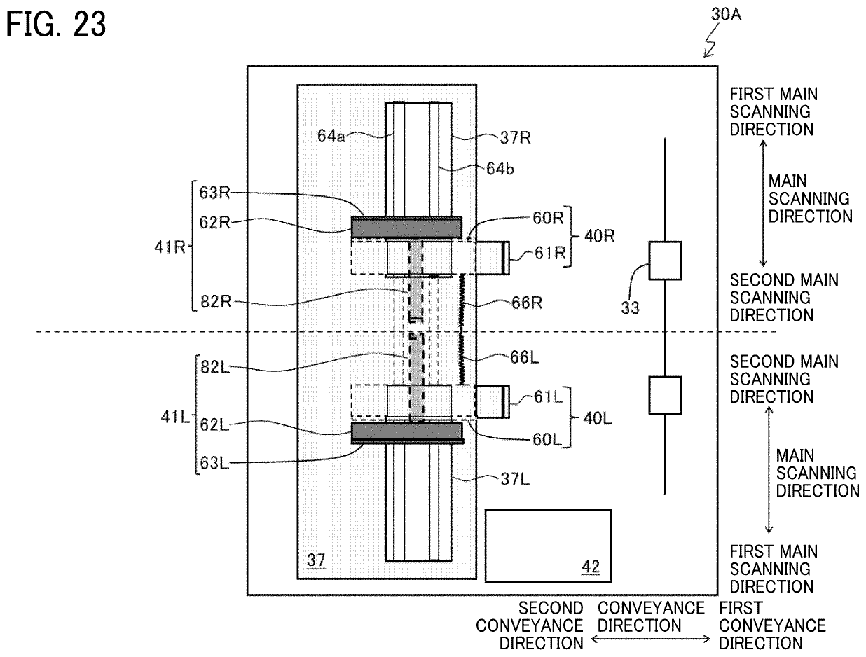

A description is given of the configuration of a sheet binder 30A according to a second embodiment, with reference to FIGS. 23 to 25. Detailed description of the common features with the first embodiment will be omitted, and the description will focus on the differences.

The first embodiment and the second embodiment are different in that the first main scanning direction and the second main scanning direction are reversed. In other words, the first main scanning direction according to the second embodiment is a direction toward an end opposite to the center in the main scanning direction of the sheet S or the sheet bundle Sb accumulated in the internal tray 37. The second main scanning direction according to the second embodiment is a direction toward the center in the main scanning direction of the sheets S or the sheet bundle Sb accumulated in the internal tray 37.

FIG. 23 is a diagram illustrating a state in which the end fences 40L and 40R and the side fences 41L and 41R according to the second embodiment are arranged at the home positions.

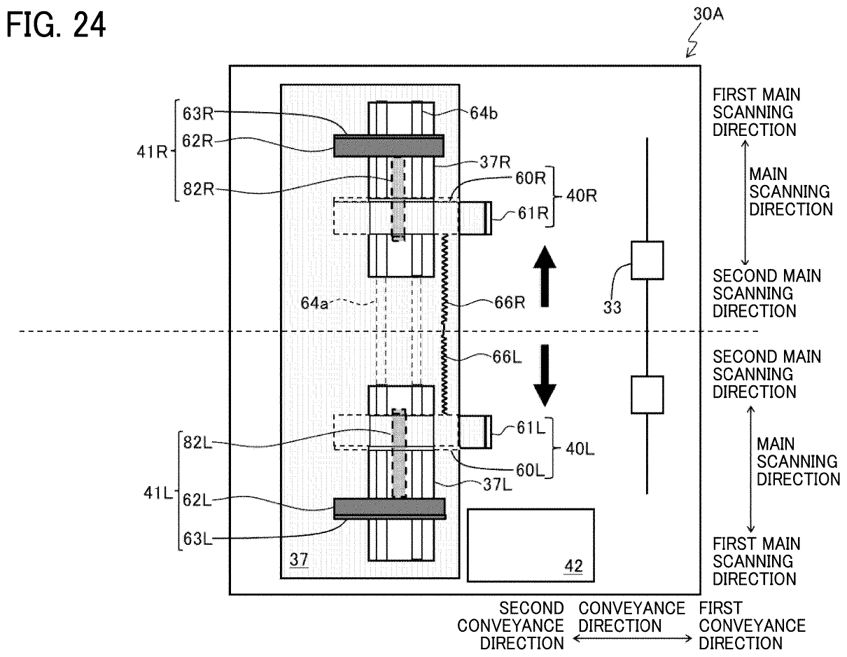

FIG. 24 is a diagram illustrating a state in which the end fences 40L and 40R according to the second embodiment are arranged at the standby positions.

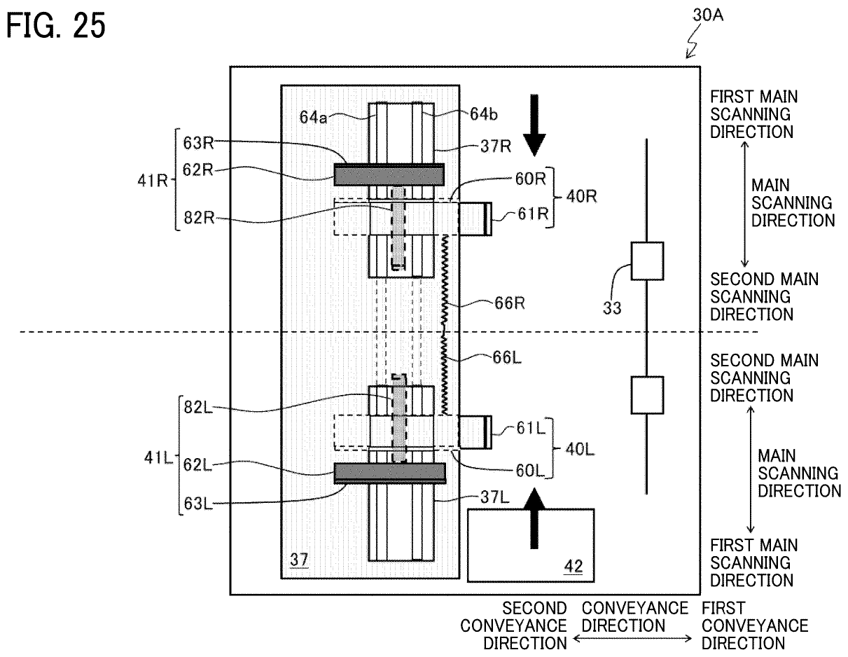

FIG. 25 is a diagram illustrating a state in which the side fences 41L and 41R according to the second embodiment are arranged at the standby positions.

As illustrated in FIGS. 23 to 25, the coil springs 66L and 66R according to the second embodiment bias the end fences 40L and 40R toward the center in the main scanning direction of the sheet S or the sheet bundle Sb accumulated in the internal tray 37. The switching mechanisms 67L and 67R according to the second embodiment are reversed in the main scanning direction as compared with the first embodiment. Furthermore, the home positions of the end fences 40L and 40R and the side fences 41L and 41R according to the second embodiment are on the center side in the main scanning direction of the sheet S or the sheet bundle Sb accumulated in the internal tray 37.

Further, as illustrated in FIGS. 23 to 25, the side fences 41L and 42R according to the second embodiment further include locking portions 82L and 82R. The locking portions 82L and 82R are portions positioned below the internal tray 37. Furthermore, the locking portions 82L and 82R are portions extending in the second main scanning direction from the guided portions 62L and 62R of the side fences 41L and 41R toward the downstream side of the end fences 40L and 40R in the second main scanning direction. Furthermore, the locking portions 82L and 82R are portions that can lock the guided portions 60L and 60R of the end fences 40L and 40R at the downstream ends in the second main scanning direction. Since the functions of the locking portions 82L and 82R are common, a description is given below of the locking portion 82L.

As illustrated in FIG. 23, when the guided portions 60L and 62L of the end fence 40L and the side fence 41L are in contact with each other, the distal end of the locking portion 82L is located on the downstream side of the guided portion 60L in the second main scanning direction while separated from the guided portion 60L.

When the fence motor 65L is rotated forward to move the side fence 41L in the first main scanning direction, the guided portions 60L and 62L are separated in the main scanning direction, and the distal end of the locking portion 82L locks (contacts) the guided portion 60L. As a result, as illustrated in FIG. 24, the end fence 40L is pulled by the side fence 41L and moves in the first main scanning direction together with the side fence 41L. As a result, the end fence 40L can be moved to a desired standby position.

Furthermore, when the fence motor 65L is reversely rotated after the end fence 40L reaches the standby position, the side fence 41L moves in the main scanning direction while keeping the end fence 40L at the standby position in a range (in other words, the extension range of the locking portion 82L) in which the guided portions 60L and 62L do not contact each other. As a result, as illustrated in FIG. 25, the side fence 41L can be moved to the standby position in a state where the end fence 40L is stopped, and jogging can be performed every time the sheet S is supplied to the internal tray 37.

The present disclosure is not limited to the embodiments described above, and various modifications are possible within the scope of the technical gist thereof, and all the technical matters included in the technical idea recited in claims are the object of the present disclosure. Although the above-described embodiments represent preferable examples, various modifications can be achieved by those skilled in the art from the disclosed contents. Such modifications are included in the technical scope recited in the claims.

Aspects of the present disclosure are, for example, as follows.

### Aspect 1

In Aspect 1, a medium processing apparatus includes a stacker to accumulate media conveyed in a conveyance direction; a conveyance direction alignment unit to align positions of a plurality of the media accumulated in the stacker in the conveyance direction, a main scanning direction alignment unit to align the positions of the plurality of the media accumulated in the stacker in main scanning directions orthogonal to the conveyance direction, a binding device to bind a medium bundle that is the media accumulated in the stacker, a drive source to move the main scanning direction alignment unit in a first main scanning direction that is one of the main scanning directions and in a second main scanning direction that is another of the main scanning directions, and a switcher to switch whether or not to allow movement of the conveyance direction alignment unit in the main scanning directions. The switcher moves the conveyance direction alignment unit in the first main scanning direction together with the main scanning direction alignment unit with the conveyance direction alignment unit being in contact with the main scanning direction alignment unit that moves in the first main scanning direction, and stops the conveyance direction alignment unit at a current position when the main scanning direction alignment unit is moving on a downstream side of the conveyance direction alignment unit in the second main scanning direction.

### Aspect 2

In Aspect 2, in the medium processing apparatus according to Aspect 1, when the first main scanning direction is a direction toward a center in the main scanning direction of the media accumulated in the stacker and the second main scanning direction is a direction toward an end opposite to the center in the main scanning direction of the media accumulated in the stacker, the switcher moves the conveyance direction alignment unit in the direction toward the center in the main scanning direction together with the main scanning direction alignment unit with the conveyance direction alignment unit being in contact with the main scanning direction alignment unit that moves in the direction toward the center in the main scanning direction, and stops the conveyance direction alignment unit at a current position when the main scanning direction alignment unit is moving on a downstream side of the conveyance direction alignment unit in the direction toward the end opposite to the center in the main scanning direction.

### Aspect 3

In Aspect 3, in the medium processing apparatus according to Aspect 1, when the second main scanning direction is a direction toward a center in the main scanning direction of the media accumulated in the stacker and the first main scanning direction is a direction toward an end opposite to the center in the main scanning direction of the media accumulated in the stacker, the switcher moves the conveyance direction alignment unit in the direction toward the end opposite to the center in the main scanning direction together with the main scanning direction alignment unit with the conveyance direction alignment unit being in contact with the main scanning direction alignment unit that moves in the direction toward the end opposite to the center in the main scanning direction, and stops the conveyance direction alignment unit at a current position when the main scanning direction alignment unit is moving on a downstream side of the conveyance direction alignment unit in the direction toward the center in the main scanning direction.

### Aspect 4

In Aspect 4, the medium processing apparatus according to any one of Aspects 1 to 3 further includes a biasing member to bias the conveyance direction alignment unit in the second main scanning direction. The switcher is switchable between a first state, in which the conveyance direction alignment unit is allowed to move in the first main scanning direction together with the main scanning direction alignment unit and the conveyance direction alignment unit is restricted from moving in the second main scanning direction by a biasing force of the biasing member and a second state, in which the conveyance direction alignment unit is allowed to move in the second main scanning direction by the biasing force of the biasing member.

### Aspect 5

In Aspect 5, in the medium processing apparatus according to Aspect 4, the switcher in the first state is switched to the second state when the conveyance direction alignment unit reaches a downstream end in the first main scanning direction.

### Aspect 6

In Aspect 6, in the medium processing apparatus according to Aspect 4 or Aspect 5, the switcher in the second state is switched to the first state when the conveyance direction alignment unit reaches a downstream end in the second main scanning direction.

### Aspect 7

In Aspect 7, the medium processing apparatus according to any one of Aspects 1 to 6 further includes a control unit to control positions of the conveyance direction alignment unit and the main scanning direction alignment unit. The control unit acquires size information indicating a size in the main scanning direction of the media accumulated in the stacker, and moves the conveyance direction alignment unit and the main scanning direction alignment unit to standby positions corresponding to the size information that has been acquired.

### Aspect 8

In Aspect 8, in the medium processing apparatus according to Aspect 7, the control unit causes the conveyance direction alignment unit and the main scanning direction alignment unit to reach the standby positions before the media constituting the medium bundle begin to be accumulated in the stacker.

### Aspect 9

In Aspect 9, the medium processing apparatus of any one of Aspects 1 to 8 further includes a position sensor to detect that the conveyance direction alignment unit is arranged at a home position in the main scanning direction, and a control unit to control a position of the conveyance direction alignment unit based on a detection result of the position sensor. The control unit moves the conveyance direction alignment unit to the home position in a case where the conveyance direction alignment unit is not detected by the position sensor when a power supply to the medium processing apparatus is started or stopped.

### Aspect 10

In Aspect 10, the medium processing apparatus of any one of Aspects 1 to 9 further includes a position sensor to detect that the conveyance direction alignment unit is arranged at a home position in the main scanning direction, and a control unit to control a position of the conveyance direction alignment unit based on a detection result of the position sensor. The medium processing apparatus is switchable between a normal mode in which power is supplied to all parts of the medium processing apparatus and an energy-saving mode in which power is supplied to merely a part of the medium processing apparatus. The control unit moves the conveyance direction alignment unit to the home position in a case where the conveyance direction alignment unit is not detected by the position sensor when the energy-saving mode is started or stopped.

### Aspect 11

In Aspect 11, an image forming system includes an image forming apparatus to form images on media, and the medium processing apparatus according to any one of Aspects 1 to 10, the medium processing apparatus being to bind a medium bundle which is a plurality of the media on which images have been formed by the image forming apparatus.

### Aspect 12

In Aspect 12, an image forming system includes an image forming unit to form images on media, a stacker to accumulate the media conveyed in a conveyance direction through the image forming unit, a conveyance direction alignment unit to align positions of a plurality of the media accumulated in the stacker in the conveyance direction, a main scanning direction alignment unit to align the positions of the plurality of the media accumulated in the stacker in main scanning directions orthogonal to the conveyance direction, a binding device to bind a medium bundle that is the plurality of the media accumulated in the stacker, a drive source to move the main scanning direction alignment unit in a first main scanning direction that is one of the main scanning directions and in a second main scanning direction that is another of the main scanning directions, and a switcher to switch whether or not to allow movement of the conveyance direction alignment unit in the main scanning directions. The switcher moves the conveyance direction alignment unit in the first main scanning direction together with the main scanning direction alignment unit with the conveyance direction alignment unit being in contact with the main scanning direction alignment unit that moves in the first main scanning direction, and stops the conveyance direction alignment unit at a current position when the main scanning direction alignment unit is moving on a downstream side of the conveyance direction alignment unit in the second main scanning direction.

### Aspect 13

In Aspect 13, the image forming system according to Aspect 11 or Aspect 12 further includes a position sensor to detect a position of the conveyance direction alignment unit in the main scanning direction, and a control unit to control a position of the conveyance direction alignment unit based on a detection result of the position sensor. In a case where the position of the conveyance direction alignment unit detected by the position sensor is different from a standby position corresponding to a size of the media on which images are formed in the main scanning direction, the control unit moves the conveyance direction alignment unit to the standby position before supplying the media to the stacker.

### Aspect 14

In Aspect 14, a medium processing apparatus includes a stacker, a first direction aligner, a second direction aligner, a binder, a drive source, and a switch. The stacker stacks media conveyed in a conveyance direction. The first direction aligner aligns a position of the media on the stacker, in the conveyance direction. The second direction aligner aligns a position of the media on the stacker, in a main scanning direction orthogonal to the conveyance direction. The second direction aligner is contactable with the first direction aligner to move the first direction aligner. The binder binds a media bundle of the media on the stacker. The drive source moves the second direction aligner in one of the main scanning direction as a first-side direction to move the first direction aligner and another of the main scanning direction as a second-side direction opposite to the first-side direction. The switch switches the first direction aligner between a first state and a second state. In the first state, the first direction aligner is allowed to move in the first-side direction by the second direction aligner, and the first direction aligner is restricted to move in the second-side direction. In the second state, the first direction aligner is allowed to move in the second-side direction.

### Aspect 15

In Aspect 15, in the medium processing apparatus according to Aspect 14, the switch includes a stopper to stop the first direction aligner at a current position in the main scanning direction in the first state, when the second direction aligner moves in a region downstream from the first direction aligner in the second-side direction.

### Aspect 16

In Aspect 16, in the medium processing apparatus according to Aspect 14, the drive source moves the second direction aligner in the first-side direction from an end of the media on a side on which the second direction aligner is disposed toward a center of the media in the main scanning direction, and the second-side direction from the center of the media toward the end of the media opposite to the center of the media in the main scanning direction. The switch allows the second direction aligner in contact with the first direction aligner to move the first direction aligner in the first-side direction toward the center in the main scanning direction. The switch stops the first direction aligner at a current position when the second direction aligner moves in a region downstream from the first direction aligner in the second-side direction toward the end of the media in the main scanning direction.

### Aspect 17

In Aspect 17, in the medium processing apparatus according to Aspect 14, the drive source moves the second direction aligner in the second-side direction from an end of the media on a side on which the second direction aligner is disposed toward a center of the media in the main scanning direction, and the first-side direction from the center of the media toward the end of the media opposite to the center of the media in the main scanning direction. The switch allows the second direction aligner to move to a first given position in the first-side direction toward the end of the media in the main scanning direction so as to move the first direction aligner to a second given position. The switch causes the first direction aligner to stop at the second given position so as not to move from the second given position when the second direction aligner moves in the second-side direction from the first given position toward the center of the media in the main scanning direction.

### Aspect 18

In Aspect 18, the medium processing apparatus according to any one of Aspects 14 to 17 further includes a bias to bias the first direction aligner in the second-side direction. The switch switches the first direction aligner between the first state and the second state. In the first state, the switch allows the second direction aligner in contact with the first direction aligner to move the first direction aligner in the first-side direction, and the switch restricts the first direction aligner from moving in the second-side direction against a biasing force of the bias. In the second state, the switch allows the bias to move the first direction aligner in the second-side direction.

### Aspect 19

In Aspect 18, in the medium processing apparatus according to Aspect 18, the switch switches the first direction aligner from the first state to the second state when the first direction aligner reaches a downstream end in the first-side direction in the main scanning direction.

### Aspect 20

In Aspect 20, in the medium processing apparatus according to Aspect 18 or Aspect 19, the switch switches the first direction aligner from the second state to the first state when the first direction aligner reaches a downstream end in the second-side direction of the main scanning direction.

### Aspect 21

In Aspect 21, the medium processing apparatus according to any one of Aspects 14 to 20 further includes circuitry to control a position of the first direction aligner and a position of the second direction aligner, acquire size information indicating a size in the main scanning direction of the medium stacked on the stacker, and move the first direction aligner and the second direction aligner to a standby position of the first direction aligner and a standby position of the second direction aligner corresponding to the acquired size information.

### Aspect 22

In Aspect 22, in the medium processing apparatus according to Aspect 21, the circuitry is further configured to cause the first direction aligner and the second direction aligner to reach a standby position of the first direction aligner and a standby position of the second direction aligner before a preceding medium of the media bundle is stacked on the stacker.

### Aspect 23

In Aspect 23, the medium processing apparatus of any one of Aspects 14 to 22 further includes a position sensor and circuitry. The position sensor detects that the first direction aligner is located at a home position in the main scanning direction. The circuitry is to control a position of the first direction aligner based on a detection result of the position sensor, and moves the first direction aligner to the home position when the first direction aligner is not detected by the position sensor at a start or a stop of a power supply to the medium processing apparatus.

### Aspect 24

In Aspect 24, the medium processing apparatus of any one of Aspects 14 to 23 further includes a position sensor and circuitry. The position sensor detects that the first direction aligner is located at a home position in the main scanning direction. The circuitry is to control a position of the first direction aligner based on a detection result of the position sensor, change between a normal mode in which a power is supplied to an entire area of the medium processing apparatus and an energy-saving mode in which the power is supplied to a part of the medium processing apparatus, and move the first direction aligner to the home position when the first direction aligner is not detected by the position sensor at a start or a stop of the energy-saving mode.

### Aspect 25

In Aspect 25, an image forming system includes an image forming apparatus to form an image on a medium, and the medium processing apparatus according to any one of Aspects 14 to 24 to bind the media bundle of media including the medium on which the image is formed by the image forming apparatus.

### Aspect 26

In Aspect 26, the image forming system according to Aspect 25 further includes a position sensor and circuitry. The position sensor detects a position of the first direction aligner in the main scanning direction. The circuitry is to cause the switch to control a position of the first direction aligner based on a detection result of the position sensor, and move the first direction aligner to a standby position corresponding to a size of the medium on which the image is formed in the main scanning direction, before the medium is conveyed to the stacker, when the position of the first direction aligner detected by the position sensor is different from the standby position.

### Aspect 27

In Aspect 27, an image forming system includes an image forming device, a stacker, a first direction aligner, a second direction aligner, a binder, a drive source, and a switch. The image forming device to form an image on a medium. The stacker stacks media conveyed from and passed through the image forming device in a conveyance direction. The first direction aligner aligns a position of the media on the stacker, in the conveyance direction. The second direction aligner aligns a position of the media on the stacker, in a main scanning direction orthogonal to the conveyance direction. The second direction aligner is contactable with the first direction aligner to move the first direction aligner. The binder binds a media bundle of the media on the stacker. The drive source moves the second direction aligner in one of the main scanning direction as a first-side direction to move the first direction aligner and another of the main scanning direction as a second-side direction opposite to the first-side direction. The switch switches the first direction aligner between a first state and a second state. In the first state, the first direction aligner is allowed to move in the first-side direction by the second direction aligner, and the first direction aligner is restricted to move in the second-side direction. In the second state, the first direction aligner is allowed to move in the second-side direction.

### Aspect 28

In Aspect 28, the image forming system according to Aspect 27 further includes a position sensor and circuitry. The position sensor detects a position of the first direction aligner in the main scanning direction. The circuitry is to cause the switch to control a position of the first direction aligner based on a detection result of the position sensor, and move the first direction aligner to a standby position corresponding to a size of the medium on which the image is formed in the main scanning direction, before the medium is conveyed to the stacker, when the position of the first direction aligner detected by the position sensor is different from the standby position.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a stacker to stack media conveyed in a conveyance direction;
a first direction aligner to align a position of the media on the stacker, in the conveyance direction;
a second direction aligner to align a position of the media on the stacker, in a main scanning direction orthogonal to the conveyance direction,
the second direction aligner contactable with the first direction aligner to move the first direction aligner;
a binder to bind a media bundle of the media on the stacker;
a drive source to move the second direction aligner in:
one of the main scanning direction as a first-side direction to move the first direction aligner; and
another of the main scanning direction as a second-side direction opposite to the first-side direction;
a switch to switch the first direction aligner between:
a first state in which:
the first direction aligner is allowed to move in the first-side direction by the second direction aligner; and
the first direction aligner is restricted to move in the second-side direction; and
a second state in which the first direction aligner is allowed to move in the second-side direction.

2. The medium processing apparatus according to claim 1,
wherein the switch includes a stopper to stop the first direction aligner at a current position in the main scanning direction in the first state, when the second direction aligner moves in a region downstream from the first direction aligner in the second-side direction.

3. The medium processing apparatus according to claim 1,
wherein the drive source moves the second direction aligner in:
the first-side direction from an end of the media on a side on which the second direction aligner is disposed toward a center of the media in the main scanning direction; and
the second-side direction from the center of the media toward the end of the media opposite to the center of the media in the main scanning direction,
the switch allows the second direction aligner in contact with the first direction aligner to move the first direction aligner in the first-side direction toward the center in the main scanning direction, and
the switch stops the first direction aligner at a current position when the second direction aligner moves in a region downstream from the first direction aligner in the second-side direction toward the end of the media in the main scanning direction.

4. The medium processing apparatus according to claim 1,
wherein the drive source moves the second direction aligner in:
the second-side direction from an end of the media on a side on which the second direction aligner is disposed toward a center of the media in the main scanning direction; and
the first-side direction from the center of the media toward the end of the media opposite to the center of the media in the main scanning direction,
the switch allows the second direction aligner to move to a first given position in the first-side direction toward the end of the media in the main scanning direction so as to move the first direction aligner to a second given position, and
the switch causes the first direction aligner to stop at the second given position so as not to move from the second given position when the second direction aligner moves in the second-side direction from the first given position toward the center of the media in the main scanning direction.

5. The medium processing apparatus according to claim 1, further comprising a bias to bias the first direction aligner in the second-side direction,
wherein the switch switches the first direction aligner between:
the first state in which:
the switch allows the second direction aligner in contact with the first direction aligner to move the first direction aligner in the first-side direction; and
the switch restricts the first direction aligner from moving in the second-side direction against a biasing force of the bias; and
the second state in which the switch allows the bias to move the first direction aligner in the second-side direction.

6. The medium processing apparatus according to claim 5,
wherein the switch switches the first direction aligner from the first state to the second state when the first direction aligner reaches a downstream end in the first-side direction in the main scanning direction.

7. The medium processing apparatus according to claim 5,
wherein the switch switches the first direction aligner from the second state to the first state when the first direction aligner reaches a downstream end in the second-side direction of the main scanning direction.

8. The medium processing apparatus according to claim 1, further comprising circuitry configured to:
control a position of the first direction aligner and a position of the second direction aligner;
acquire size information indicating a size in the main scanning direction of the media stacked on the stacker; and
move the first direction aligner and the second direction aligner to a standby position of the first direction aligner and a standby position of the second direction aligner corresponding to the acquired size information.

9. The medium processing apparatus according to claim 8,
wherein the circuitry is further configured to cause the first direction aligner and the second direction aligner to reach a standby position of the first direction aligner and a standby position of the second direction aligner before a preceding medium of the media bundle is stacked on the stacker.

10. The medium processing apparatus according to claim 1, further comprising:
a position sensor to detect that the first direction aligner is located at a home position in the main scanning direction; and
circuitry configured to:
control a position of the first direction aligner based on a detection result of the position sensor; and
move the first direction aligner to the home position when the first direction aligner is not detected by the position sensor at a start or a stop of a power supply to the medium processing apparatus.

11. The medium processing apparatus according to claim 1, further comprising:
a position sensor to detect that the first direction aligner is located at a home position in the main scanning direction; and
circuitry configured to:
control a position of the first direction aligner based on a detection result of the position sensor;
change between:
a normal mode in which a power is supplied to an entire area of the medium processing apparatus; and
an energy-saving mode in which the power is supplied to a part of the medium processing apparatus; and
move the first direction aligner to the home position when the first direction aligner is not detected by the position sensor at a start or a stop of the energy-saving mode.

12. An image forming system comprising:
an image forming apparatus to form an image on a medium; and
the medium processing apparatus according to claim 1 to bind the media bundle of media including the medium on which the image is formed by the image forming apparatus.

13. The image forming system according to claim 12, further comprising:
a position sensor to detect a position of the first direction aligner in the main scanning direction; and
circuitry configured to:
cause the switch to control a position of the first direction aligner based on a detection result of the position sensor; and
move the first direction aligner to a standby position corresponding to a size of the medium on which the image is formed in the main scanning direction, before the medium is conveyed to the stacker, when the position of the first direction aligner detected by the position sensor is different from the standby position.

14. An image forming system comprising:
an image forming device to form an image on a medium;
a stacker to stack media conveyed from and passed through the image forming device in a conveyance direction;
a first direction aligner to align a position of the media on the stacker, in the conveyance direction;
a second direction aligner to align a position of the media on the stacker, in a main scanning direction orthogonal to the conveyance direction,
the second direction aligner contactable with the first direction aligner to move the first direction aligner;
a binder to bind a media bundle of the media on the stacker;
a drive source to move the second direction aligner in:
one of the main scanning direction as a first-side direction to move the first direction aligner; and
another of the main scanning direction as a second-side direction opposite to the first-side direction; and
a switch to switch the first direction aligner between:
a first state in which:
the first direction aligner is allowed to move in the first-side direction by the second direction aligner; and
the first direction aligner is restricted to move in the second-side direction; and
a second state in which the first direction aligner is allowed to move in the second-side direction.

15. The image forming system according to claim 14, further comprising:
a position sensor to detect a position of the first direction aligner in the main scanning direction; and
circuitry configured to:
cause the switch to control a position of the first direction aligner based on a detection result of the position sensor, and
move the first direction aligner to a standby position corresponding to a size of the medium on which the image is formed in the main scanning direction, before the medium is conveyed to the stacker, when the position of the first direction aligner detected by the position sensor is different from the standby position.
